(19) United States
(12) Patent Application Publication
(10) Pub. No.: US 2007/0139306 A1
(43) Pub. Date: Jun. 21, 2007

(54) Plasma display panel with simultaneous address drive operation and sustain drive operation

(76) Inventor: Toyoshi Kawada, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/638,381

(22) Filed: Dec. 14, 2006

(30) Foreign Application Priority Data
Dec. 19, 2005 (JP) 2005-365098

(51) Int. Cl. G09G 3/28

(52) U.S. Cl. 345/67

(57) ABSTRACT

A circuit for driving a plasma display panel which includes first electrodes, second electrodes, and third electrodes extending substantially perpendicular to the first and second electrodes includes a first driver circuit configured to drive the first electrodes, a second driver circuit configured to drive the second electrodes, a third driver circuit configured to drive the third electrodes, and a control circuit configured to control the first through third driver circuits such as to perform an address drive operation and a sustain drive operation simultaneously in parallel by performing the sustain drive operation to apply a sustain voltage between a first electrode and a second electrode adjacent to each other so as to sustain electric discharge at display cells while performing the address drive operation to successively apply a scan voltage to the first electrodes and apply an address voltage to the third electrodes so as to select the display cells.

### BACKGROUND OF THE INVENTION

1. Field of the Invention

The present invention generally relates to plasma-display apparatuses, circuits for driving such apparatuses, and methods of driving such apparatuses, and particularly relates to a sub-frame-method-based plasma display apparatus, a circuit for driving such apparatus, and a method of driving such apparatus.

2. Description of the Related Art

Flat display apparatuses using flat display panels have been put to practical use in wide areas of application from small displays to large displays, and are replacing the conventional cathode-ray tubes. In the field of large-size displays, the plasma display panel (PDP) is regarded as superior due to its advantageous characteristics derived from the principle of operation and configuration, and are commercialized as mainstream products.

In order to facilitate further promulgation of the products, cost reduction of the apparatuses, improvements in the display characteristics, and further improvements in functionalities are desired. Moreover, there is an increasing demand for the reduction of various impacts on the environment such as EMI. In order to make further market progress into ordinary households, the further reduction of environmental impacts is necessary.

FIG. 1 is a cross-sectional view of a three-electrode-type flat-plane-discharge AC-PDP panel serving as an example of a large-size display apparatus.

The three-electrode-type flat-plane-discharge AC-PDP panel includes two glass substrates, i.e., a front glass substrate 15 and a rear glass substrate 11. On the front glass substrate 15, common sustain electrodes (X electrodes) and scan electrodes (Y electrodes), each of which is comprised of a sustain-purpose BUS electrode 17 and transparent electrode 16, are formed. The X electrodes and the Y electrodes alternate with each other. A dielectric layer 18 is formed on the X electrodes and Y electrodes, and a protective layer 19 made of MgO or the like is formed on top of the dielectric layer 18.

The BUS electrode 17 has high conductivity, and serves as reinforcement for the conductivity of the transparent electrode 16. The protective layer 19 is made of low-melting-point glass, and serves to maintain discharge based on wall charge.

Address electrodes 12 are formed on the rear glass substrate 11 in such a manner as to extend perpendicularly to the X electrodes and Y electrodes. A dielectric layer 13 is formed on the address electrodes 12. On the dielectric layer 13, partition walls 14 are formed at positions corresponding to the gaps between the address electrodes 12.

Between the partition walls 14, fluorescent layers R, G, and B are formed to cover the dielectric layer 13 and the side walls of the partition walls. The fluorescent layers R, G, and B correspond to red, green, and blue, respectively. When the PDP is driven, electric discharge between the X electrodes and the Y electrodes generates ultraviolet light, which excites the fluorescent layers R, G, and B to emit light, thereby providing display presentation.

The gap between the front panel having the X electrodes and Y electrodes and the rear panel having the address electrodes 12 is filled with discharge gas such as a mixture of neon and xenon. Space at the position where an X electrode and Y electrode intersect with an address electrode constitutes a single discharge cell (pixel).

FIG. 2 is a block diagram showing a main part of a drive circuit for the three-electrode-type flat-plane-discharge AC-PDP panel. A drive circuit shown in FIG. 2 includes an address driver circuit 111, a scan driver circuit 112, a Y common driver circuit 113, an X common driver circuit 114, and a control circuit 115. The control circuit 115 includes a display data control circuit 116, a scan driver control circuit 117, and a common driver control circuit 118. The display data control circuit 116 includes a frame memory 119.

The control circuit 115 receives a clock signal CLK, display data D, a vertical synchronizing signal VSYNC, a horizontal synchronizing signal HSYNC, etc., from an external source, and generates control signals for controlling the panel operation based on the received signals and data. To be specific, the display data control circuit 116 receives the display data D for storage in the frame memory 119, and generates an address control signal responsive to the display data D stored in the frame memory 119 in synchronization with the clock signal CLK. The address control signal is supplied to the address driver circuit 111. The scan driver control circuit 117 generates a scan driver control signal for controlling the scan driver circuit 112 in synchronization with the vertical synchronizing signal VSYNC and the horizontal synchronizing signal HSYNC. The common driver control circuit 118 drives the Y common driver circuit 113 and the X common driver circuit 114 in synchronization with the vertical synchronizing signal VSYNC and the horizontal synchronizing signal HSYNC.

The address driver circuit 111 operates in response to the address control signal supplied from the display data control circuit 116, and applies address voltage pulses responsive to the display data to address electrodes A1 through Am. The scan driver circuit 112 operates in response to the scan driver control signal supplied from the scan driver control circuit 117, and drives scan electrodes (Y electrodes) Y1 through Yn independently of each other. While the scan driver circuit 112 successively drives the scan electrodes (Y electrodes) Y1 through Yn, the address driver circuit 111 applies address voltage pulses to the address electrodes A1 through Am, thereby selecting cells to emit light so as to control display/non-display (selected-state/unselected-state) of each cell 103.

The Y common driver circuit 113 applies sustain voltage pulses to the Y electrodes Y1 through Yn, and the X common driver circuit 114 applies sustain voltage pulses to the X electrodes X1 through Xn. The application of these sustain voltage pulses generates sustain discharge between an X electrode and a Y electrode at the cells selected as display cells. The address electrodes A1 through Am, X electrodes X1 through Xn, and Y electrodes Y1 through Yn are disposed between a front glass substrate 101 (corresponding to 15 in FIG. 1) and a rear glass substrate 102 (corresponding to 11 in FIG. 1). Further, partition walls 106 (corresponding to 14 in FIG. 1) are provided between the address electrodes A1 through Am.

FIG. 3 is a waveform diagram showing an example of a basic operation of the drive circuit of FIG. 2. The drive period of a PDP mainly consists of a reset period, an address period, and a sustain period. In the reset period, each display pixel is initialized. In the address period that follows, pixels to be displayed (i.e., pixels to emit light) is selected. In the sustain period that comes last, the selected pixels are caused to emit light.

In the reset period, voltage waveforms as shown in FIG. 3 are applied to the Y electrodes Y1 through Yn serving as scan electrodes and to the X electrodes X1 through Xn, thereby initializing the state of all the display cells. Namely, the cells that were displayed on a preceding occasion and the cells that were not displayed on the preceding occasion are equally initialized to the same state.

In the address period, scan voltage pulses at the −Vy level are successively applied to the Y electrodes Y1 through Yn serving as scan electrodes, thereby driving the Y electrodes Y1 through Yn one by one. In synchronization with the application of the scan voltage pulses to the Y electrodes, address voltage pulses at the Va level are applied to the address electrodes (A1 through Am). This serves to select display cells on each scan line.

In the sustain period, sustain pulses (sustain voltage pulses) at the common Vs level (Vsy, Vsx) are alternately supplied to all the scan electrodes Y1 through Yn and the X common electrodes X1 through Xn With this arrangement, the pixels selected in the address period are cause to emit light. The continuous application of sustain pulses then achieves a display at predetermined luminance levels.

This basic operation of applying a series of drive waveforms may be combined with other basic operations to control the number of light emissions, thereby making it possible to represent gray tones. FIG. 4 is a drawing for explaining a method of displaying gray scales based on a sub-frame method that is widely employed today.

FIG. 4 illustrates a case in which 1024 gray scales are displayed by use of 10 sub-frames. Each of 10 sub-frames SF1 through SF10 is comprised of the reset period (“RESET DRIVE TIMING” in FIG. 4), the address period, and the sustain period (“SUSTAIN DRIVE PERIOD”). Drive operations for the reset period and the address period are substantially the same between different sub-frames, but the number of sustain pulses in the sustain period differs from sub-frame to sub-frame. Sub-frames having different numbers of sustain pulses are combined together to represent a desired gray scale.

There are many ways to assign the numbers of sustain pulses to the 10 sub-frames. In general, the numbers of sustain pulses in the 10 sub-frames are set to 2⁰=1, 2¹=2, 2²=4, . . . , and 2⁹=512, respectively. Sub-frames forming a desired combination of sub-frames selected from these 10 sub-frames are caused to emit light, thereby making it possible to represent 1024 gray scales at the maximum.

The grayscale displaying method based on the conventional sub-frame method as described above is advantageous as it is relatively easy to control because display control is performed by using drive periods including the reset period, address period, and sustain period that are clearly separated in terms of their functions. In order to provide a sufficient time for each of the reset period, the address period, and the sustain period, however, the length of each sub-frame becomes undesirably long.

One completed set of sub-frames is referred to as a frame. Frames need to be displayed at 60 Hz or more in order to prevent flicker from appearing on screen, which means that each frame needs to be shorter than 16.7 ms. Due to such time restriction, an increase in the length of sub-frames results in a decreased number of sub-frames in one frame, thereby giving rise to a problem in that a sufficient number of gray scales are not provided.

Conversely, if an attempt is made to provide a sufficient number of sub-frames for the purpose of securing a sufficient number of gray scales, the time length that can be allocated to the driving of each of the reset period, address period, and sustain period becomes insufficient. As a result, a problem arises in that operation margin and drive stability degrade, creating a situation in which erroneous display may easily occur.

Further, since the plurality of drive periods are clearly separate from each other, and are used for respective, different drive operations as described above, the amount of required drive currents differs significantly from drive period to drive period. To be specific, the amount of electric current required for the sustain period is significantly larger than the amount of electric currents required in the other periods, giving rise to a problem in that there is large fluctuation in the consumed currents.

If the fluctuating component of the power-supply current (ripple current) is large, there is a need to provide a control circuit such as a stabilizer circuit that has a sufficient capacity to cope with the maximum value (peak current) of the fluctuating component, and, also, there is a need to provide circuit elements for interconnects having sufficient capacity. As a result, the apparatus becomes complex and expensive, which is disadvantageous from the cost point of view. Further, an increase in the peak current component means an increase in the radiation of noise signals from the drive circuits, thereby increasing the probability of circuit control suffering malfunction. There is another problem in that impact on the surrounding environment may become large due to the radiation of electromagnetic energy.

[Patent Document 1] Japanese Patent Application Publication No. 11-352925

Accordingly, there is a need for a sub-frame-method-based plasma display apparatus, a drive circuit, and a drive method that can provide a sufficient address drive period and sufficient sustain drive period while improving the performance of grayscale display. Further, there is a need for a sub-frame-method-based plasma display apparatus, a drive circuit, and a drive method that can reduce electric current fluctuation.

### SUMMARY OF THE INVENTION

It is a general object of the present invention to provide a plasma display apparatus, a drive circuit, and a drive method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a plasma display apparatus, a drive circuit, and a drive method particularly pointed out in the specification in such full, clear, concise, and exact terms as to enable a person having ordinary skill in the art to practice the invention.

To achieve these and other advantages in accordance with the purpose of the invention, the invention provides a circuit for driving a plasma display panel in which display cells are constituted at least by a set of electrodes including first electrodes extending in a first direction, second electrodes extending in the first direction, and third electrodes extending in a second direction substantially perpendicular to the first direction. The circuit includes a first driver circuit configured to drive the first electrodes, a second driver circuit configured to drive the second electrodes, a third driver circuit configured to drive the third electrodes, and a control circuit configured to control the first through third driver circuits such as to perform an address drive operation and a sustain drive operation simultaneously in parallel by performing the sustain drive operation to apply a sustain voltage between a first electrode and a second electrode adjacent to each other so as to sustain electric discharge at the display cells while performing the address drive operation to successively apply a scan voltage to the first electrodes and apply an address voltage to the third electrodes so as to select the display cells.

According to another aspect of the present invention, a method of driving a plasma display panel, in which display cells are constituted at least by a set of electrodes including first electrodes extending in a first direction, second electrodes extending in the first direction, and third electrodes extending in a second direction substantially perpendicular to the first direction, includes a reset drive step of applying a reset voltage to the first electrodes and the second electrodes, an address drive step of successively applying a scan voltage to the first electrodes and applying an address voltage to the third electrodes so as to select the display cells, and a sustain drive step of applying a sustain voltage between a first electrode and a second electrode adjacent to each other so as to sustain electric discharge at the display cells, wherein the address drive step and the sustain drive step are performed at least partially simultaneously in parallel.

According to another aspect of the present invention, a plasma display apparatus includes a plasma display panel in which display cells are constituted at least by a set of electrodes including first electrodes extending in a first direction, second electrodes extending in the first direction, and third electrodes extending in a second direction substantially perpendicular to the first direction, a first driver circuit configured to drive the first electrodes, a second driver circuit configured to drive the second electrodes, a third driver circuit configured to drive the third electrodes, and a control circuit configured to control the first through third driver circuits such as to perform an address drive operation and a sustain drive operation simultaneously in parallel by performing the sustain drive operation to apply a sustain voltage between a first electrode and a second electrode adjacent to each other so as to sustain electric discharge at the display cells while performing the address drive operation to successively apply a scan voltage to the first electrodes and apply an address voltage to the third electrodes so as to select the display cells.

According to at least one embodiment of the present invention, provision is made to simultaneously perform the address drive operation and the sustain drive operation in parallel with respect to the plasma display panel. This can ensure the provision of a sufficient address drive period and a sufficient sustain drive period, and achieves drive operations with reduced current fluctuation. Further, the increase of the speed of drive operation and the shortening of drive time serve to improve display performance such as the capability of grayscale representation and the capability of high-luminance display.

### BRIEF DESCRIPTION OF THE DRAWINGS

Other objects and further features of the present invention will be apparent from the following detailed description when read in conjunction with the accompanying drawings, in which:

FIG. 1 is a cross-sectional view of a three-electrode-type flat-plane-discharge AC-PDP panel;

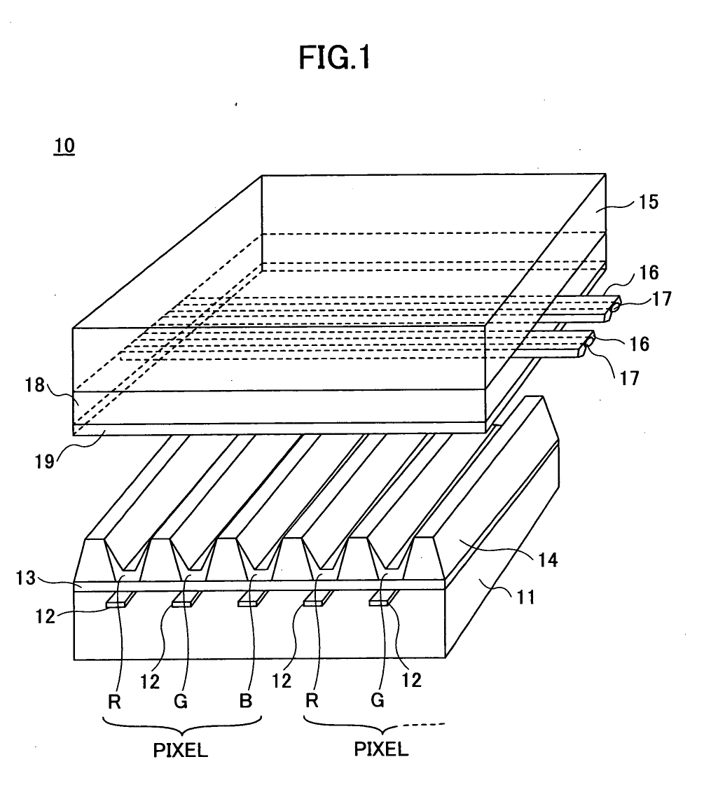

FIG. 2 is a block diagram showing a main part of a drive circuit for the three-electrode-type flat-plane-discharge AC-PDP panel;

FIG. 3 is a waveform diagram showing an example of a basic operation of the drive circuit of FIG. 2;

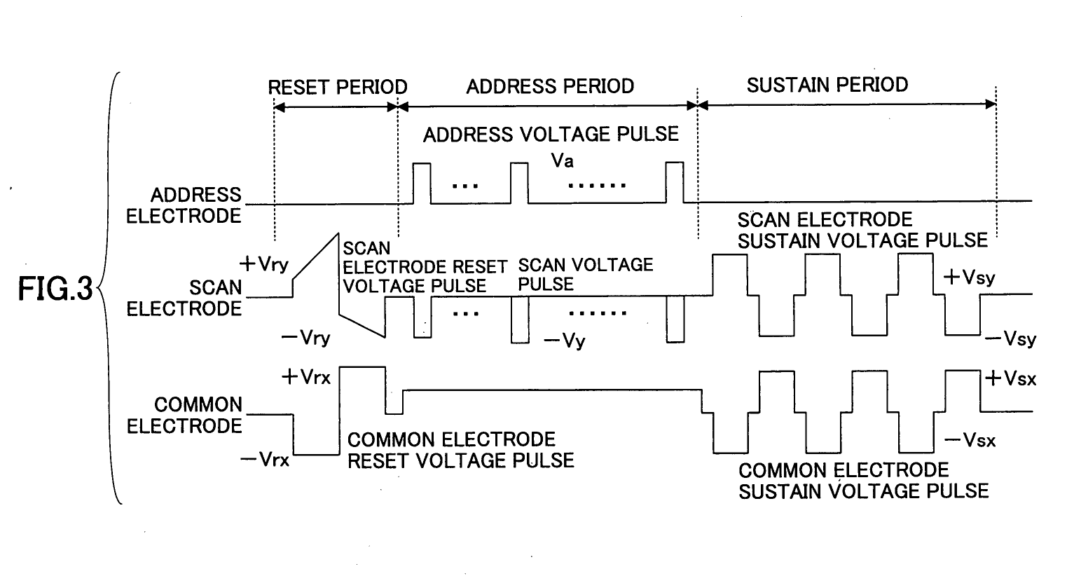

FIG. 4 is a drawing for explaining a method of displaying gray scales based on a sub-frame method;

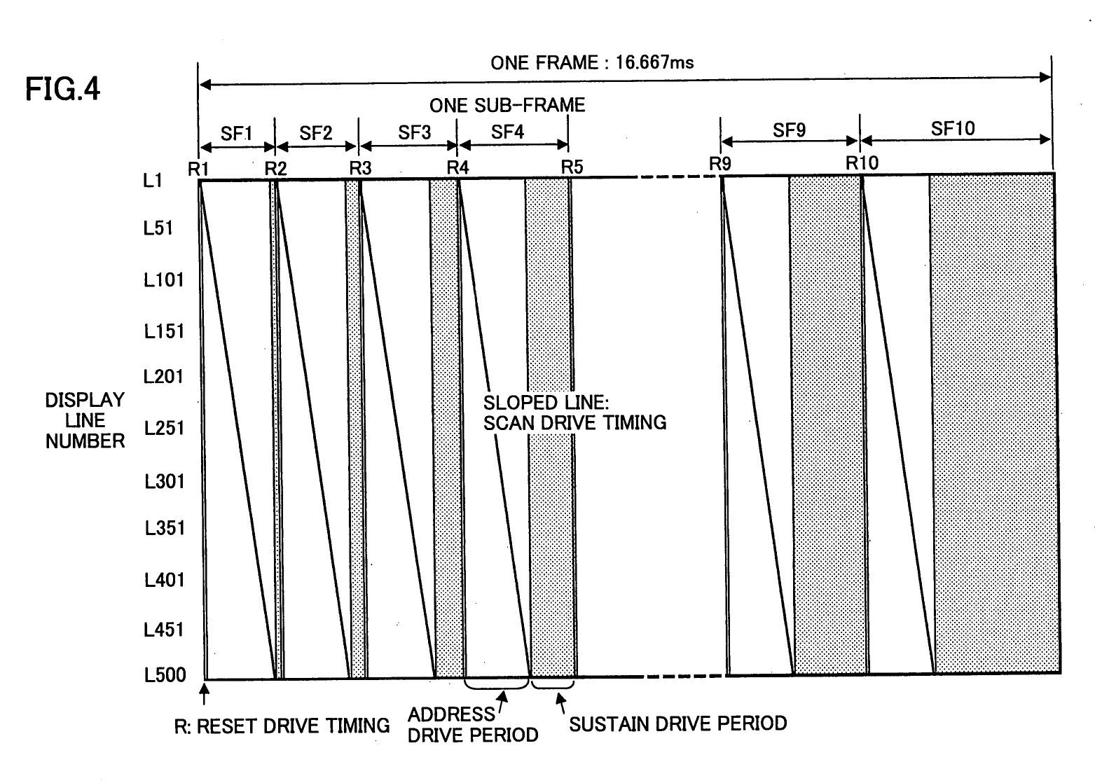

FIG. 5 is a drawing for explaining the basic principle of the present invention;

FIG. 6A is a drawing for explaining the detail of drive timing of a sub-frame;

FIG. 6B is a drawing for explaining the detail of drive timing of a sub-frame;

FIG. 6C is a drawing for explaining the detail of drive timing of a sub-frame;

FIG. 6D is a drawing for explaining the detail of drive timing of a sub-frame;

FIG. 6E is a drawing for explaining the detail of drive timing of a sub-frame;

FIG. 7 is a block diagram showing a main part of a PDP panel drive circuit according to the present invention;

FIG. 8 is a drawing showing an example of a basic circuit configuration of a Y-electrode scan driver circuit and an X-electrode driver circuit;

FIG. 9 is a signal waveform diagram showing an example of a drive waveform according to the present invention;

FIG. 10 is a signal waveform diagram showing another example of a drive waveform according to the present invention;

FIG. 11 is a drawing showing the configuration of an entire frame according to a first embodiment of a grayscale drive method of the present invention;

FIG. 12A is a drawing showing an example of drive waveforms of a sub-frame of the frame shown in FIG. 11;

FIG. 12B is a drawing showing an example of drive waveforms of a sub-frame of the frame shown in FIG. 11;

FIG. 12C is a drawing showing an example of drive waveforms of a sub-frame of the frame shown in FIG. 11;

FIG. 13 is a drawing showing the configuration of an entire frame according to a second embodiment of a grayscale drive method of the present invention;

FIG. 14 is a drawing showing an example of drive waveforms of a sub-frame of the frame shown in FIG. 13;

FIG. 15 is a drawing showing the configuration of an entire frame according to a third embodiment of a grayscale drive method of the present invention;

FIG. 16 is a drawing showing an example of drive waveforms of a sub-frame of the frame shown in FIG. 15;

FIG. 17 is a drawing for explaining a fourth embodiment of a grayscale drive method of the present invention;

FIG. 18 is a drawing for explaining a fourth embodiment of a grayscale drive method of the present invention;

FIG. 19 is a drawing for explaining a fifth embodiment of a grayscale drive method of the present invention;

FIG. 20 is a drawing showing an example of the configuration of the Y-electrode scan driver circuit;

FIG. 21 is a drawing showing an example of the configuration of the Y driver;

FIG. 22 is a drawing showing signal waveforms generated by the Y-electrode scan driver circuit;

FIG. 23 is a drawing showing an example of the configuration of the X-electrode driver circuit;

FIG. 24 is a drawing showing an example of the configuration of the X driver; and

FIG. 25 is a drawing showing signal waveforms generated by the X-electrode driver circuit.

### DESCRIPTION OF THE PREFERRED EMBODIMENTS

In the following, embodiments of the present invention will be described with reference to the accompanying drawings.

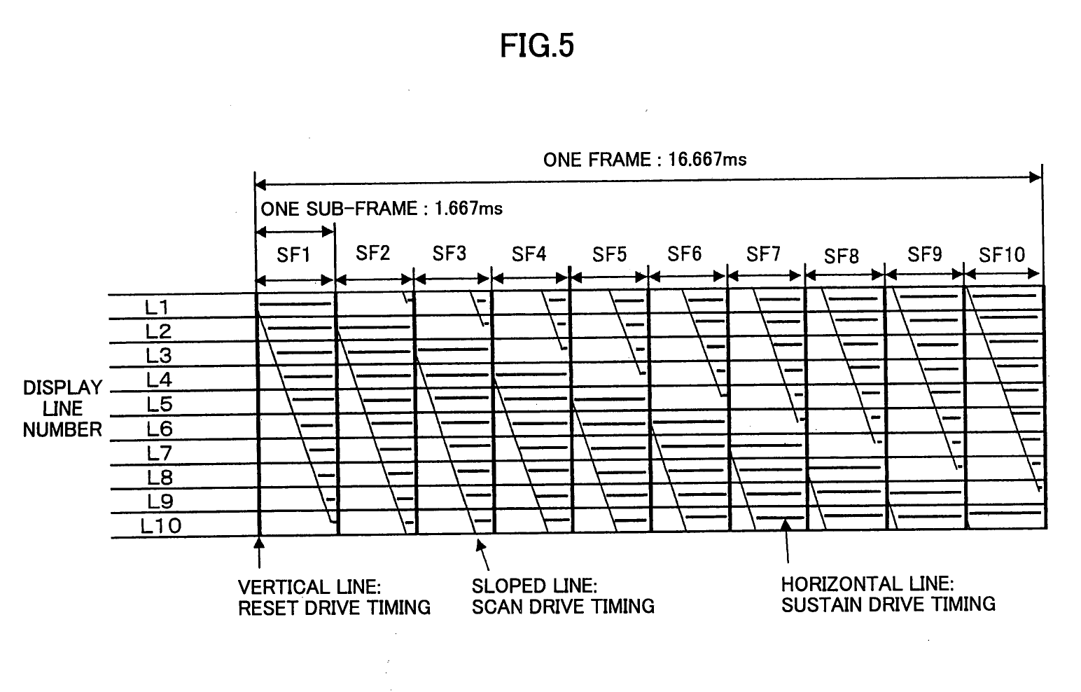

FIG. 5 is a drawing for explaining the basic principle of the present invention. In FIG. 5, for the sake of convenience of explanation, 10 display lines L1 through L10 are provided, and one frame is comprised of 10 sub-frames. Such configuration is not a limiting example, and the present invention is equally applicable to configurations having other numbers of display lines and other numbers of sub-frames.

As shown in FIG. 5, one frame of 16.667 ms is equally divided so as to provide sub-frames SF1 through SF10 having an equal length (1.667 ms). Each sub-frame is comprised of three types of drive operations, i.e., a reset drive operation, a scan drive operation (address drive operation), and a sustain drive operation.

Drive operation starts with the first sub-frame SF1. At the start of the sub-frame, the reset drive operation is performed with respect to all the display lines, thereby setting the state of all the display cells to the initial state. The same applies in the case of the following sub-frames SF2 through SF10. That is, the reset drive operation is performed at the start of each sub-frame to initialize all the display cells.

Following the reset drive operation, the address and sustain drive period comes in which an address (scan) operation and a sustain operation are successively performed with respect to the display lines L1 through L10. In FIG. 5, the timing indicated by sloped lines corresponds to the timing at which the scan drive operation (address drive operation) is performed with respect to the display lines L1 through L10. The address electrodes are driven while the scan drive operation drives the display lines (Y electrodes) one by one in order, thereby selecting cells to emit light on each driven display line.

In FIG. 5, the sustain drive operation is performed at the timing indicated by horizontal lines following the scan drive timing indicated by the sloped lines. For the display line L1, for example, the duration of the sustain drive operation is the longest for the first sub-frame SF1, and is the shortest for the second sub-frame SF2. The length of the sustain drive operation increases gradually on a step-by-step manner from the second sub-frame SF2 to the tenth sub-frame SF10. With this arrangement, 10 sub-frames having sustain drive operations of 10 different lengths are provided.

For the display line L2, for example, the duration of the sustain drive operation is the second longest for the first sub-frame SF1, and is the longest for the second sub-frame SF2. The duration of the sustain drive operation is the shortest in the third sub-frame SF3. The length of the sustain drive operation increases gradually on a step-by-step manner from the third sub-frame SF3 to the tenth sub-frame SF10. With this arrangement, 10 sub-frames having sustain drive operations of 10 different lengths are provided.

In this manner, 10 sub-frames having sustain drive operations of 10 different durations are provided for each display line. Sub-frames forming a desired combination of sub-frames selected from these 10 sub-frames are caused to emit light, thereby making it possible to represent a desired gray scale. When looking at the entirety of the display lines L1 through L10, the address drive operation and the sustain drive operation are simultaneously performed in parallel. That is, the drive period is not clearly divided into an address period and a sustain drive period.

In the present invention as described above, the address drive operation and the sustain drive operation are concurrently performed in parallel in the address and sustain drive operation, thereby significantly reducing the time required for the address and sustain drive operation compared with the case in which the address period and the sustain drive period are separately provided to perform the address drive operation and the sustain drive operation separately from each other as in the related-art configuration. Further, the sustain drive operation is being performed in at least some of the display lines during the most period of any given sub-frame, so that sudden fluctuation in electric currents can be suppressed.

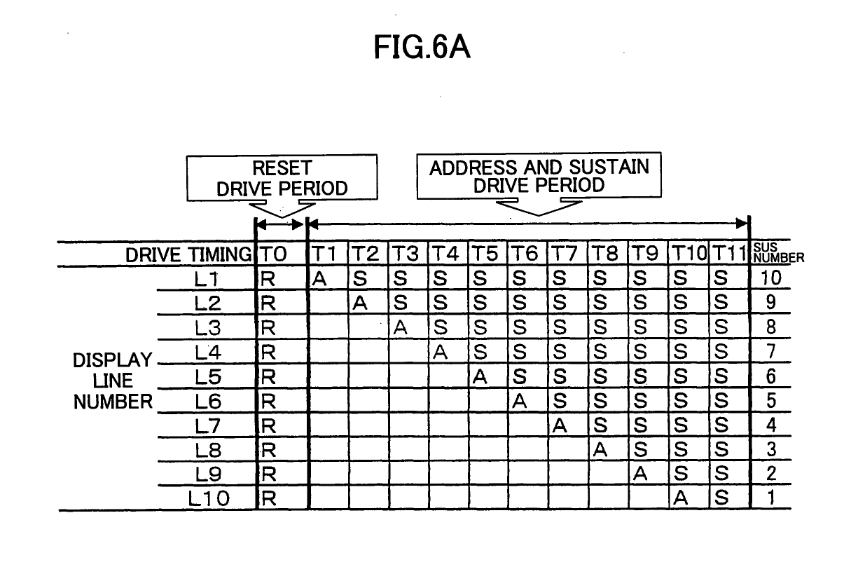

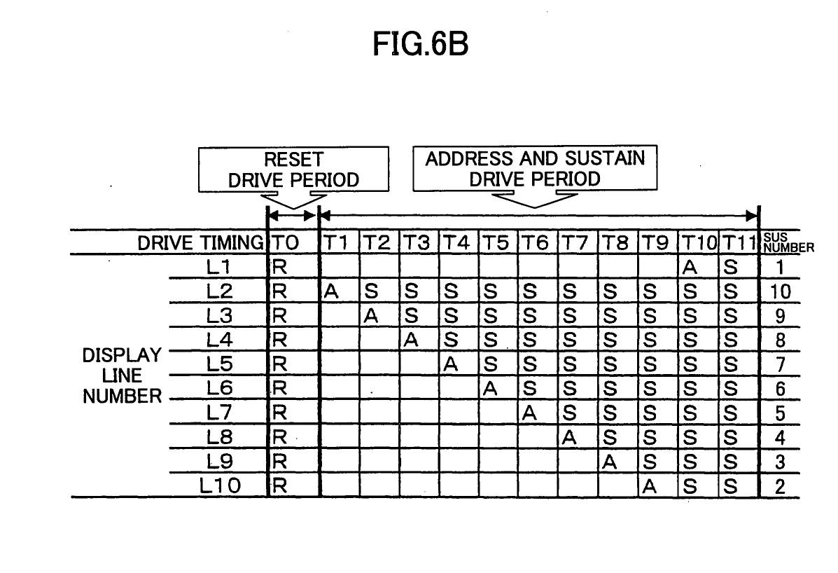

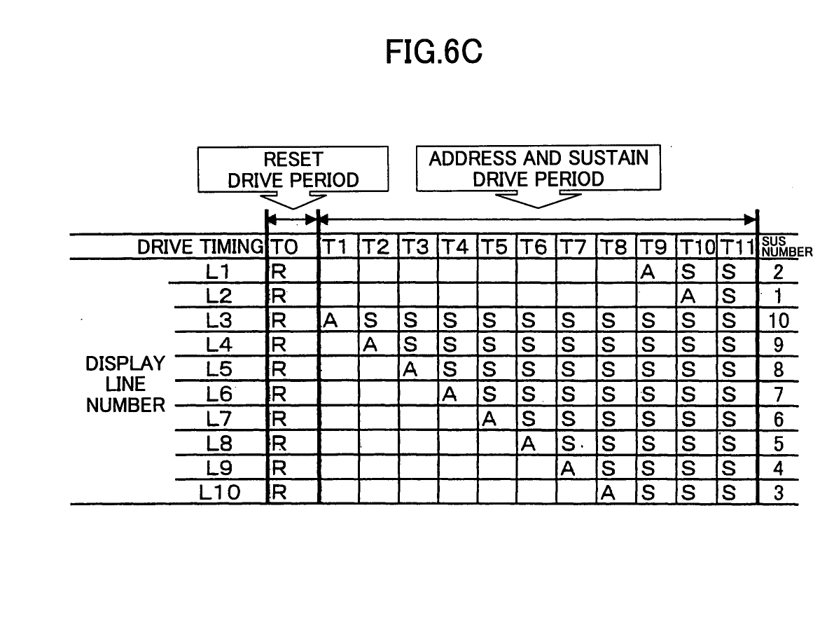

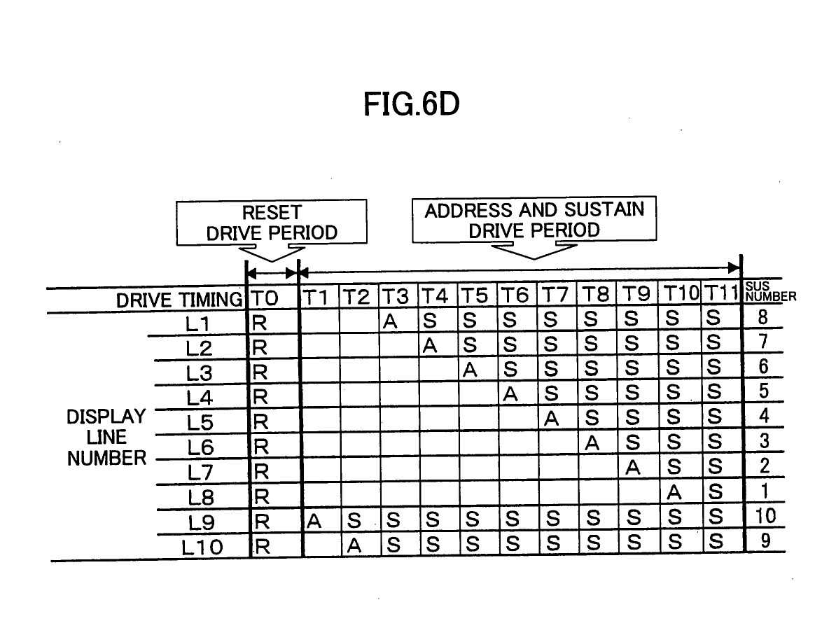

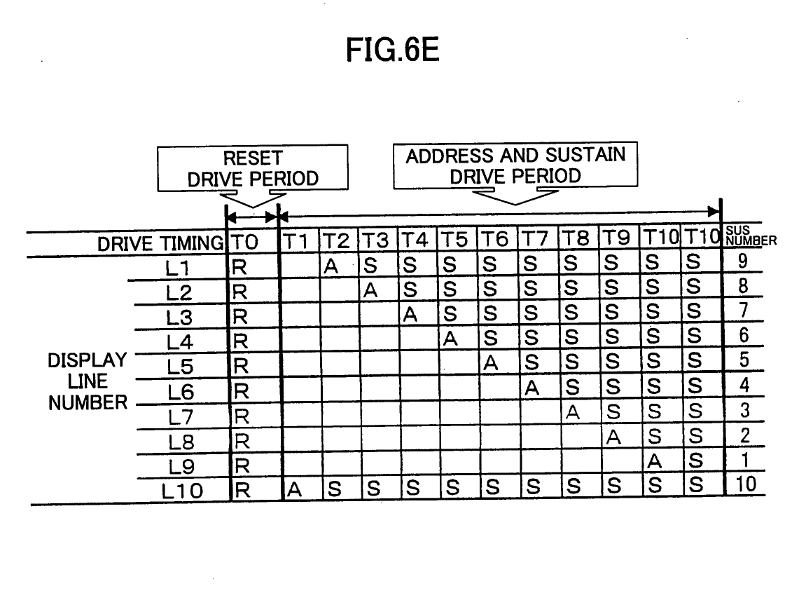

FIGS. 6A through 6E are drawings for explaining the drive timing of sub-frames. FIG. 6A illustrates the sub-frame SF1, FIG. 6B the sub-frame SF2, FIG. 6C the sub-frame SF3, FIG. 6D the sub-frame SF9, and FIG. 6E the sub-frame SF10.

Each sub-frame is subjected to timing control using drive timings T0 through T11. At the start timing T0 of each sub-frame, the reset drive operation R is performed with respect to all the display lines L1 through L10, thereby setting the state of all the display cells to the initial state. Following the reset drive operation R, the address and sustain drive period comes in which an address (scan) operation A and a sustain drive operation S are performed with respect to each of the display lines.

In the address and sustain drive period of the sub-frame SF1, as shown in FIG. 6A, the address drive operation A is performed with respect to the display line L1 at the timing T1. After this, at the timings T2 through T10, the address drive operation A is successively performed with respect to the display lines L2 through L10.

In so doing, the address drive operation A is performed for L2 at the timing T2, and, at the same time, the sustain drive operation S is performed in parallel for L1 for which the address drive operation has already been completed. By the same token, the address drive operation A is performed for L3 at the timing T3, and, at the same time, the sustain drive operation S is performed in parallel for both L1 and L2 for which the address drive operation has already been completed. Such operations are repeated until T10.

At the last timing T11, the sustain drive operation S is performed for all the display lines L1 through L10 inclusive of L10 for which the address drive operation was completed at the immediately preceding timing. After this sustain drive operation, the address and sustain drive period comes to an end.

With the address and sustain drive operation performed as described above for the sub-frame SF1, the sustain drive operation S is performed 10 times through once with respect to the display lines L1 through L10, respectively. This achieves the provision of gray scales based on the sustain drive operations having different durations for respective display lines.

Transition is then made from the sub-frame SF1 to the sub-frame SF2 shown in FIG. 6B, and the respective drive operations corresponding to the reset drive period and the address and sustain drive period are performed similarly to the manner described above. In the sub-frame SF2, the display line at which the address drive operation A is performed at the first timing T1 is set to a different display line than that of the sub-frame SF1. To be specific, the address drive operation A starts from the display line L2 adjacent to the display line L1 in this example.

Other operations are the same as in the case of the sub-frame SF1, so that the sustain drive operation S is performed on the display lines for which the address drive operation A is completed, until the drive operation comes to an end at the timing T11. With the address and sustain drive operation performed as described above for the sub-frame SF2, the sustain drive operation S is performed once with respect to the display line L1, and the sustain drive operation S is performed 10 times through 2 times with respect to the display lines L2 through L10, respectively. This achieves the provision of gray scales based on the sustain drive operations having different durations for respective display lines while making the number of sustain drive operations for each display line different from those of SF1.

In the sub-frame SF3 shown in FIG. 6C, the display line at which the address drive operation A is performed at the first timing T1 is the display line L3. In the sub-frame SF9 shown in FIG. 6D, the display line at which the address drive operation A is performed at the first timing T1 is the display line L9. In the sub-frame SF10 shown in FIG. 6E, the display line at which the address drive operation A is performed at the first timing T1 is the display line L10. In any one of these sub-frames, the sustain drive operation S is performed on the display lines for which the address drive operation A is completed, until the drive operation comes to an end at the timing T11.

Through the operations as described above, the numbers of sustain drive operations from 1 to 10 are assigned to each one of the display lines after the completion of one frame. Further, sub-frames may be combined to perform a desired number of sustain drive operations from the smallest number 1 to the largest number 55 (=1+2+3+ . . . +10) with respect to any given display line. This achieves 56 gray scales including the state of no light emission.

Each of the sub-frames SF1 through SF10 described above is comprised of the 11 timings T1 through T11. This number is limiting, and the number of sustain drive operations S may be increased as appropriated. The configuration of the present invention thus possesses great latitude in gray scale representation.

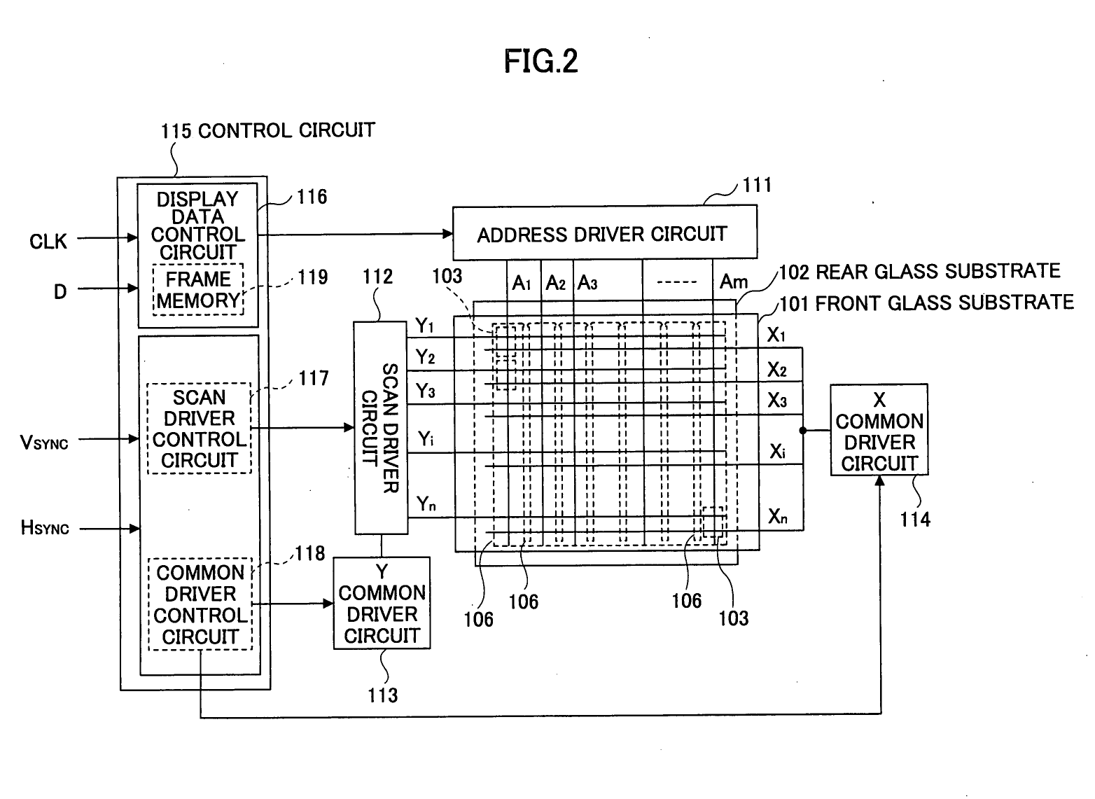

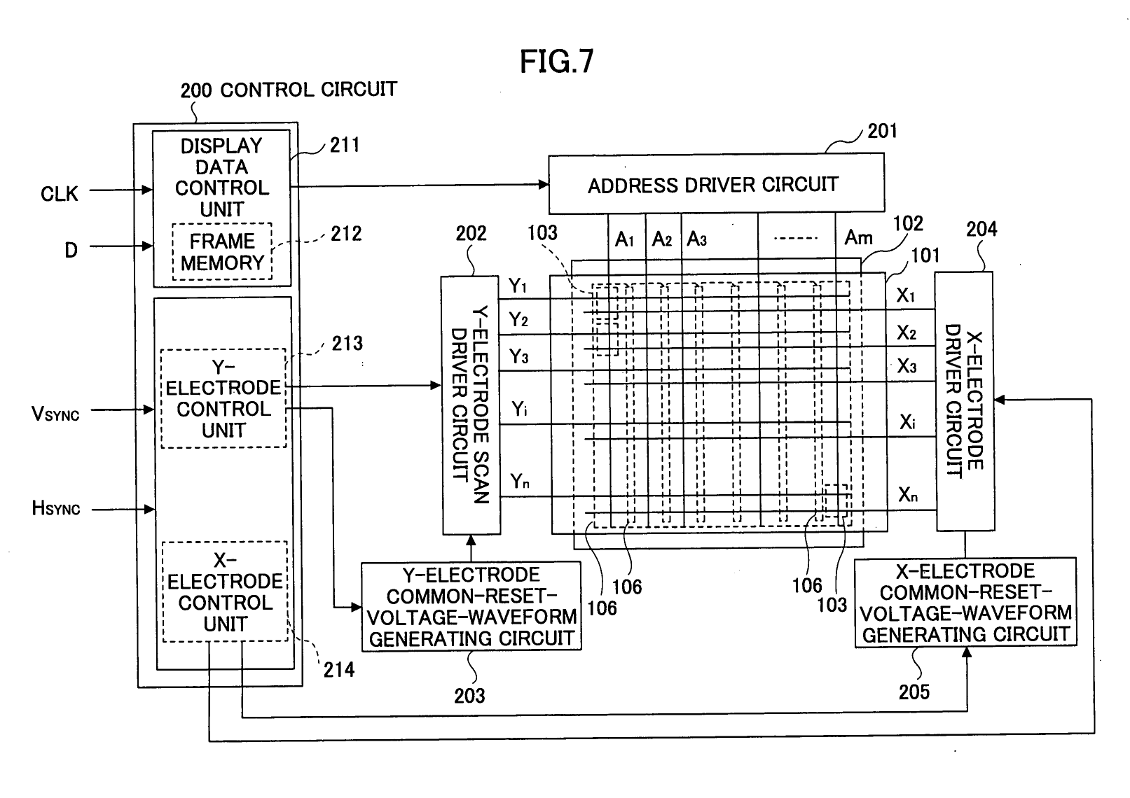

FIG. 7 is a block diagram showing a main part of a PDP panel drive circuit according to the present invention. In FIG. 7, the same elements as those of FIG. 2 are referred to by the same numerals, and a description thereof will be omitted.

A drive circuit shown in FIG. 7 includes a control circuit 200, an address driver circuit 201, a Y-electrode scan driver circuit 202, a Y-electrode common-reset-voltage-waveform generating circuit 203, an X-electrode driver circuit 204, and an X-electrode common-reset-voltage-waveform generating circuit 205. The control circuit 200 includes a display data control unit 211, a Y-electrode control unit 213, and an X-electrode control unit 214. The display data control unit 211 includes a frame memory 212.

The control circuit 200 receives a clock signal CLK, display data D, a vertical synchronizing signal VSYNC, a horizontal synchronizing signal HSYNC, etc., from an external source, and generates control signals for controlling the panel operation based on the received signals and data. To be specific, the display data control unit 211 receives the display data D for storage in the frame memory 212, and generates an address control signal responsive to the display data D stored in the frame memory 212 in synchronization with the clock signal CLK. The address control signal is supplied to the address driver circuit 201. The Y-electrode control unit 213 generates a Y-electrode-scan driver control signal for controlling the Y-electrode scan driver circuit 202 and the Y-electrode common-reset-voltage-waveform generating circuit 203 in synchronization with the vertical synchronizing signal VSYNC and the horizontal synchronizing signal HSYNC. The X-electrode control unit 214 generates an X-electrode driver control signal for controlling the X-electrode driver circuit 204 and the X-electrode common-reset-voltage-waveform generating circuit 205 in synchronization with the vertical synchronizing signal VSYNC and the horizontal synchronizing signal HSYNC.

The address driver circuit 201 operates in response to the address control signal supplied from the display data control unit 211, and applies address voltage pulses responsive to the display data to address electrodes A1 through Am. The Y-electrode scan driver circuit 202 operates in response to the scan driver control signal supplied from the Y-electrode control unit 213, and drives scan electrodes (Y electrodes) Y1 through Yn independently of each other. While the Y-electrode scan driver circuit 202 successively drives the scan electrodes (Y electrodes) Y1 through Yn, the address driver circuit 201 applies address voltage pulses to the address electrodes A1 through Am, thereby selecting cells to emit light so as to control display/non-display (selected-state/unselected-state) of each cell 103.

The Y-electrode scan driver circuit 202 controls the Y electrodes Y1 through Yn independently of each other, and applies sustain voltage pulses specific to respective display lines to the Y electrodes Y1 through Yn so as to perform sustain drive operations different for respective display lines as shown in FIG. 5 and FIGS. 6A through 6E. The X-electrode driver circuit 204 controls the X electrodes X1 through Xn independently of each other, and applies sustain voltage pulses specific to respective display lines to the X electrodes X1 through Xn so as to perform sustain drive operations different for respective display lines as shown in FIG. 5 and FIGS. 6A through 6E. The application of sustain voltage pulses as described above generates sustain discharge between an X electrode and a Y electrode at the cells selected as display cells.

In the related-art configuration shown in FIG. 2, during the sustain drive period, the Y common driver circuit 113 applies common sustain voltage pulses to all the Y electrodes Y1 through Yn, and the X common driver circuit 114 applies common sustain voltage pulses to all the X electrodes X1 through Xn. In the present invention, sustain drive operations different for respective display lines are performed as shown in FIG. 5 and FIGS. 6A through 6E, so that the sustain drive operations are performed by controlling the Y electrodes Y1 through Yn independently of each other, and the sustain drive operations are performed by controlling the X electrodes X1 through Xn independently of each other.

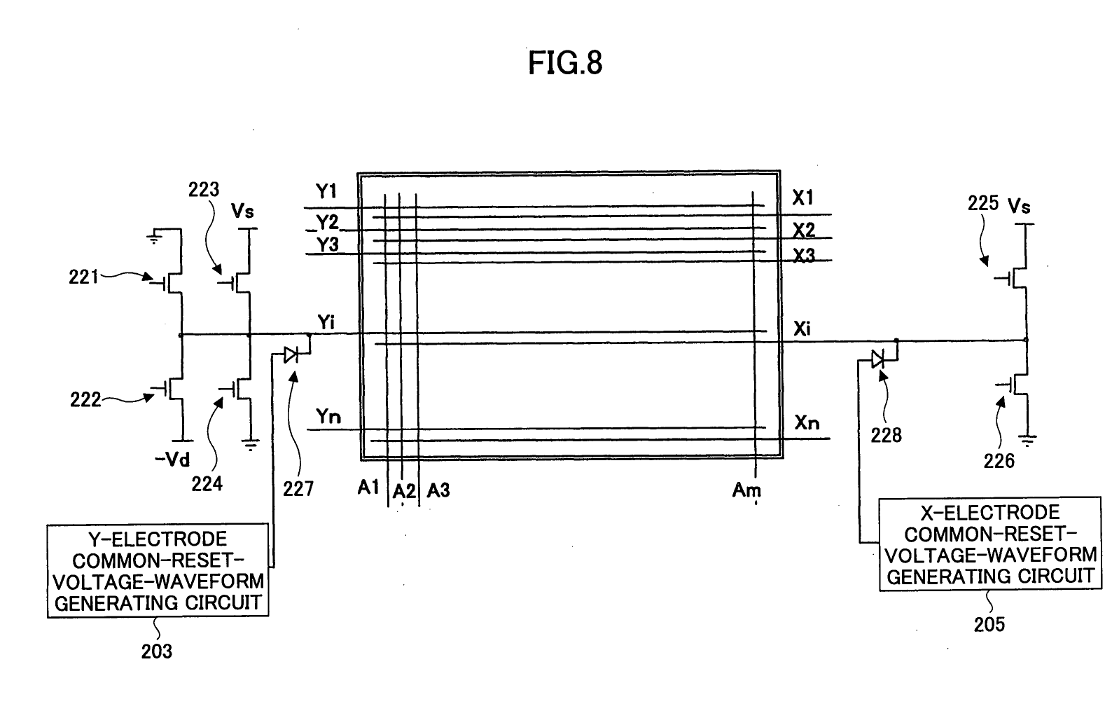

FIG. 8 is a drawing showing an example of a basic circuit configuration of the Y-electrode scan driver circuit and the X-electrode driver circuit. In FIG. 8, switch elements 221 through 224 comprised of NMOS or PMOS transistors correspond to the driver portion of the Y-electrode scan driver circuit 202 with respect to a Y electrode Yi among the Y electrodes Y1 through Yn, for example. Further, switch elements 225 and 226 comprised of NMOS or PMOS transistors correspond to the driver portion of the X-electrode driver circuit 204 with respect to an X electrode Xi among the X electrodes X1 through Xn, for example.

The switch elements 221 and 222 are provided for the purpose of applying scan voltage pulses (−Vd level) for address drive operation to the Y electrode Yi. At the time of address drive operation, the switch elements 221 and 222 are placed in the nonconductive state and conductive state, respectively, for a predetermined duration, thereby applying a voltage −Vd having a predetermined pulse width as a scan voltage pulse to the Y electrode Yi. The switch elements 223 and 224 are provided for the purpose of applying sustain voltage pulses (Vs level) for sustain drive operation to the Y electrode Yi. At the time of sustain drive operation, the switch elements 223 and 224 are placed in the conductive state and nonconductive state, respectively, for a predetermined duration, thereby applying a voltage Vs having a predetermined pulse width as a sustain voltage pulse to the Y electrode Yi. Such sustain voltage pulse is applied repeatedly.

The Y electrode Yi is coupled to the Y-electrode common-reset-voltage-waveform generating circuit 203 via a diode 227. The Y-electrode common-reset-voltage-waveform generating circuit 203 generates a reset voltage, and supplies the common reset voltage to all the Y electrodes Y1 through Yn.

The switch elements 225 and 226 are provided for the purpose of applying sustain voltage pulses (Vs level) for sustain drive operation to the X electrode Xi. At the time of sustain drive operation, the switch elements 225 and 226 are placed in the conductive state and nonconductive state, respectively, for a predetermined duration, thereby applying a voltage Vs having a predetermined pulse width as a sustain voltage pulse to the X electrode Xi. Such sustain voltage pulse is applied repeatedly.

The X electrode Xi is coupled to the X-electrode common-reset-voltage-waveform generating circuit 205 via a diode 228. The X-electrode common-reset-voltage-waveform generating circuit 205 generates a reset voltage, and supplies the common reset voltage to all the X electrodes X1 through Xn.

In the present invention, the switch elements 223 and 224 for applying sustain voltage pulses for sustain drive operation to the Y electrode Yi are controlled independently of the switch elements for applying sustain voltage pulses for sustain drive operation to other Y electrodes. Namely, the signals supplied to the control gates of the switch elements 223 and 224 are different for each Y electrode. Further, the switch elements 225 and 226 for applying sustain voltage pulses for sustain drive operation to the X electrode Xi are controlled independently of the switch elements for applying sustain voltage pulses for sustain drive operation to other X electrodes. Namely, the signals supplied to the control gates of the switch elements 225 and 226 are different for each X electrode.

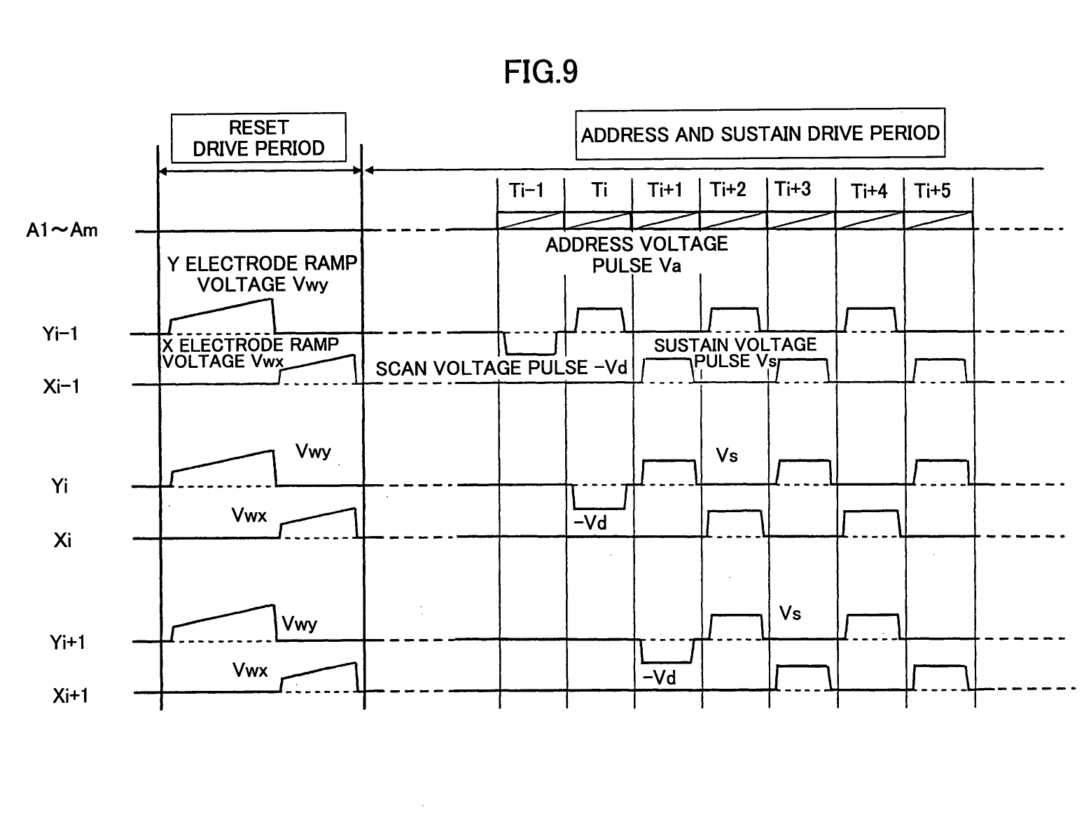

FIG. 9 is a signal waveform diagram showing an example of a drive waveform according to the present invention. In the reset drive period, the common-reset-voltage-waveform generating circuit is driven first for the Y electrodes, thereby applying to all the Y electrodes a reset voltage pulse having a ramp-shape increase reaching a peak voltage Vwy. After this, the common-reset-voltage-waveform generating circuit is driven for the X electrodes, thereby applying to all the X electrodes a reset voltage pulse having a ramp-shape increase reaching a peak voltage Vwx. The reset voltage pulses are applied to the Y electrodes and X electrodes in turn as described above so as to effectively remove electric charge remaining at the display cells formed between these electrodes, which achieves a smooth transition to the initial state. In FIG. 9, the reset voltage waveforms are applied first to the Y electrodes and then to the X electrodes. Conversely, it may be applied first to the X electrodes and then to the Y electrodes. Further, the peak voltages Vwy and Vwx and the slope of the ramp may be optimized and determined as appropriate.

After this, drive pulses are applied to each electrode in the address and sustain drive period. FIG. 9 illustrates the appearance of the voltage waveforms in the proximity of the display line Li (corresponding to the Y electrode Yi and the X electrode Xi) while providing an enlarged view around the timing Ti.

The address drive operation is performed at the timing Ti with respect to the display line Li. To be specific, a scan voltage pulse (−Vd level) is applied to the Yi electrode, and, at the same time, an address voltage pulse (Va level) is applied to selected address electrodes. This creates wall charge at the selected display cells on the display electrode Yi, and causes these cells to enter the state of sustained light emission. Thereafter, sustain voltage pulses (Vs level) are applied between the Yi electrode and the Xi electrode in an alternating manner, thereby reversing the created wall charge to continue the state of sustained light emission.

With respect to the display line Li+1, the address drive operation is performed at timing Ti+1, followed by performing sustain drive operations between the Yi+1 electrode and the Xi+1 electrode in an alternating manner. In so doing, the address voltage pulses (Va level) applied to the address electrodes for the purpose of the display line Li+1 are driven at the same timing as the sustain voltage pulse (Vs level) applied to the electrode Yi that has already been placed in the state of sustain drive operation. In this case, there may be a concern that the address voltage pulses for Li+1 affect the sustain drive operation for Li.

In an example of FIG. 9, therefore, Va and Vs are set to the same polarity to avoid summation of electrical fields, and the Va level is set lower than the Vs level (e.g., Va<⅓Vs) so as to reduce the magnitude of the electrical field of the Va level in the cells. This provision can reduce an adverse effect on the sustain-drive-purpose wall charge inside the cells.

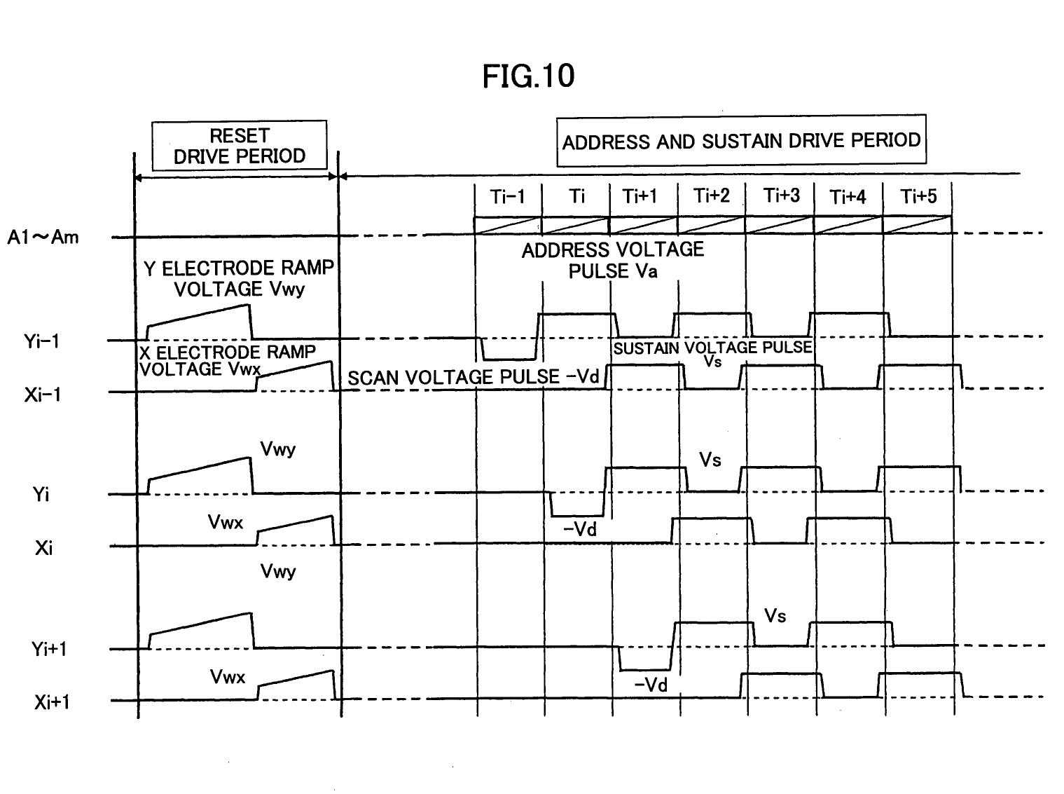

FIG. 10 is a signal waveform diagram showing another example of a drive waveform according to the present invention. The drive waveform shown in FIG. 10 is designed to reduce the effect of address voltage pulses on the sustain drive operation as described above.

In FIG. 10, the sustain voltage pulses for the Y electrodes and the sustain voltage pulses for the X electrodes are configured to overlap each other. This ensures that the sustain voltage is always present between the Y electrodes and the X electrodes during the sustain drive period, so that the created wall charge is stuck to the Y electrodes or X electrodes at all times. With this provision, the effect of application of voltages to the address electrodes on the sustain drive operation can almost be ignored.

It should be noted that in the waveforms of basic drive operations shown in FIG. 9 and FIG. 10, the phases of the sustained voltage pulses are aligned between the Xi electrode of the display line Li and the Yi+1 electrode of the adjacent display line Li+1. This serves to avoid the consumption of charge/discharge electric power between the Xi electrode and the Yi+1 electrode, thereby achieving reduction in power consumption.

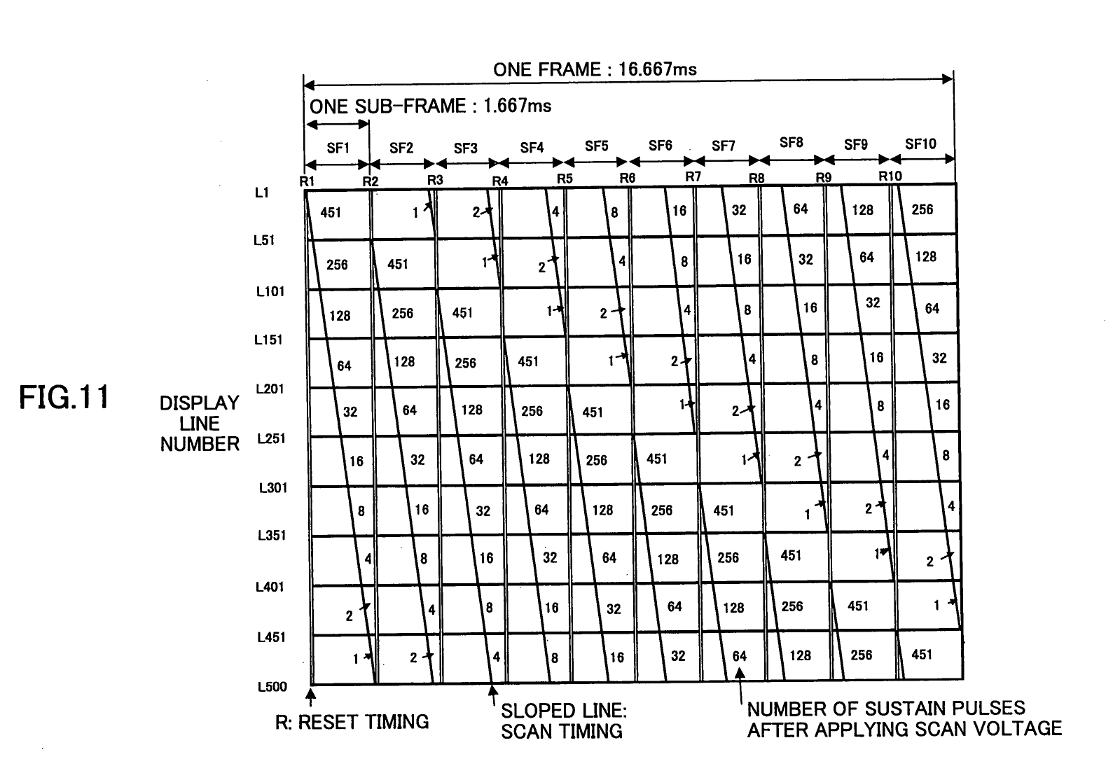

FIG. 11 is a drawing showing the configuration of an entire frame according to a first embodiment of a grayscale drive method of the present invention. In the first embodiment shown in FIG. 11, 10 sub-frames and 10-fold division are used for a panel having 500 display lines so as to provide 963 gray scales.

When 10-fold division is made, every 50 lines of all the display lines are put together from the top to the bottom so as to generate 10 blocks. Within each block, all the display lines are subjected to the sustain drive operation having the same duration and the same number of drive operations. For all the display lines L1 through L50, for example, the number of sustain drive operations is 451 in the first sub-frame SF1. For all the display lines L151 through L200, for example, the number of sustain drive operations is 128 in the second sub-frame SF2.

In FIG. 11, the reset drive operation is performed at the start timing of each sub-frame so as to initialize all the display cells. Following the reset drive operation, the address and sustain drive period comes in which the address (scan) operation and the sustain operation are successively performed with respect to the display lines. The timing indicated by sloped lines corresponds to the timing at which the scan drive operation (address drive operation) is performed with respect to the display lines. The numerical value indicated in each box defined by the sub-frames and the blocks is the number of sustain drive operations (i.e., the number of sustain pulses).

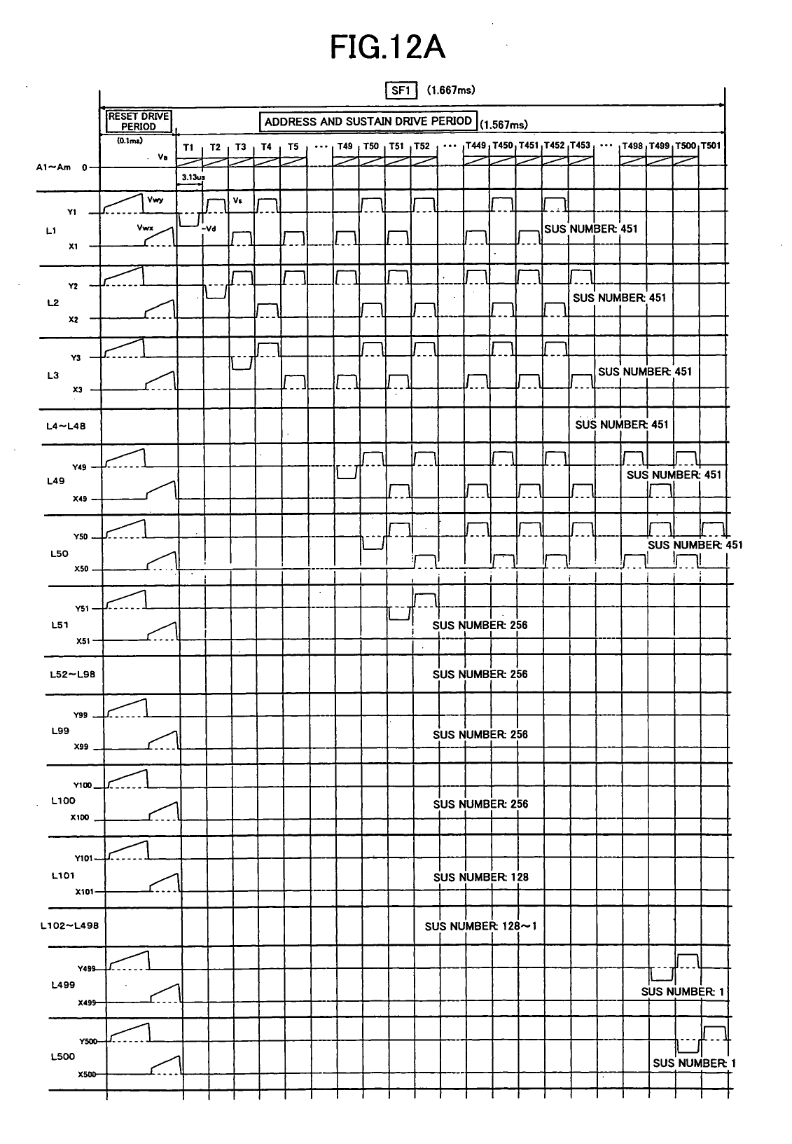

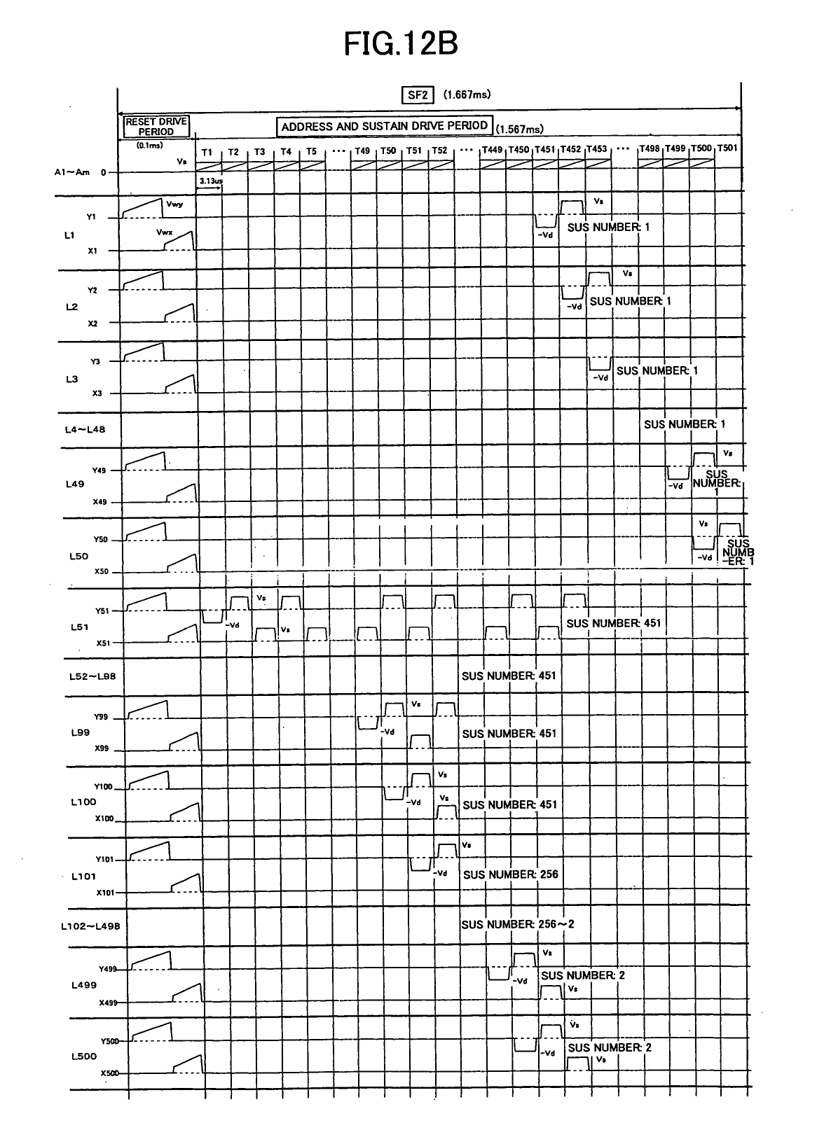

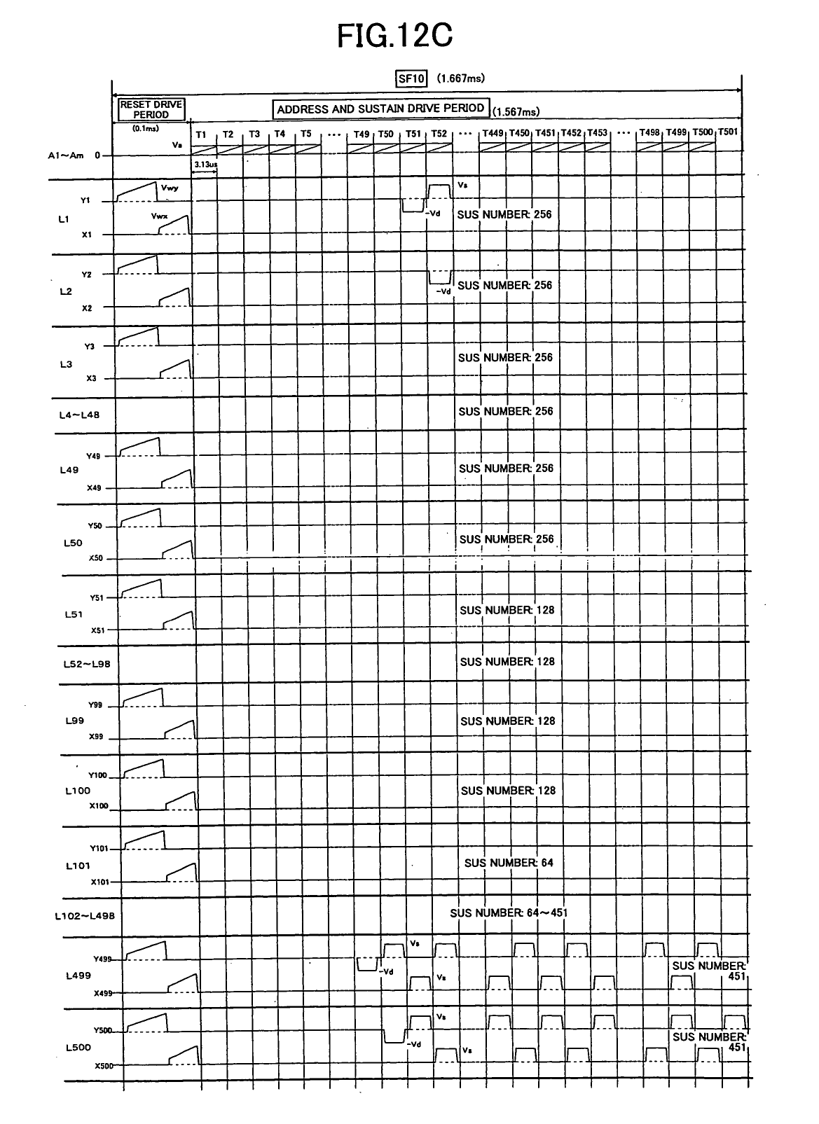

FIGS. 12A through 12C are drawings showing examples of drive waveforms for some of the sub-frames of the frame shown in FIG. 11, and illustrate the details for the sub-frame SF1, SF2, and SF10, respectively.

The length of one frame needs to be set to 16.667 ms as previously described, so that one frame becomes 1.667 ms. This length of one sub-frame is divided into the reset drive period and the address and sustain drive period. Further, the address and sustain drive period is divided into 501 timings T1 through T501, which is the sum of 500 address drive operations for the 500 display lines and one sustain drive operation for the display line for which the last address drive operation is performed. One timing corresponds to one sustain drive voltage pulse (i.e., one sustain drive operation).

As shown in FIG. 12A, it is the block of the display lines L1 through L50 that is subjected to the first address drive operation in the first sub-frame SF1. The address drive operation starts from the display line L1, and is successively performed by moving to a next adjacent display line. After the address drive operation is completed with respect to the display line L50 at the timing T50, the sustain drive operation is performed with respect to the display line L50 from the timing T51. Since the last timing is T501, the maximum number of sustain drive operations is 451 (=501−50). Namely, with respect to each and every one of the display lines L1 through L50, the sustain drive operation is started at the timing immediately following the address drive operation, and is performed 451 times. In FIG. 12A, the number of sustain drive operations is indicated as a SUS number.

The block for which the address drive operation is performed next is the display lines L51 through L100. After the address drive operation is performed with respect to the display line L100 at the timing T100, the sustain drive operation is performed with respect to the display line L100 by starting from the timing T101. In so doing, the number of sustain drive operations in respect of the display line L100 is 401 at the maximum. In this example, however, the number of sustain drive operations is set to 256, which is a power-of-two value that is easy to control. Namely, with respect to each and every one of the display lines L51 through L100, the sustain drive operation is started at the timing immediately following the address drive operation, and is performed 256 times.

As shown in FIG. 11, the number of sustain drive operations is set to power-of-two values with respect to other blocks corresponding to the display line L101 onwards, and is set to 128, 64, . . . , 1, respectively. When the driving of the sub-frame SF1 comes to an end, the driving of the sub-frame SF2 starts.

As shown in FIG. 12B, the address drive operation in the second sub-frame SF2 is started after the reset drive operation from the display line L51 that is the first line in the second block. Accordingly, the number of sustain drive operations is 451 for the second block, 256 for the third block, . . . , 2 for the 10-th block, and 1 for the first block, as shown in FIG. 11.

As shown in FIG. 12C, the address drive operation in the sub-frame SF10 is started after the reset drive operation from a display line that is in the tenth block. Accordingly, the number of sustain drive operations is 451 for the tenth block, 256 for the first block, . . . , and 1 for the ninth block, as shown in FIG. 11.

In this manner, the 500-display-line panel is divided tenfold, and 10 sub-frames are used in the first embodiment. A desired combination of sub-frames are then selected from these 10 sub-frames, thereby achieving the displaying of 963 gray scales at the maximum (=451+256+128+64+32+16+8+4+2+1+1 [corresponding to the turned-off state]).

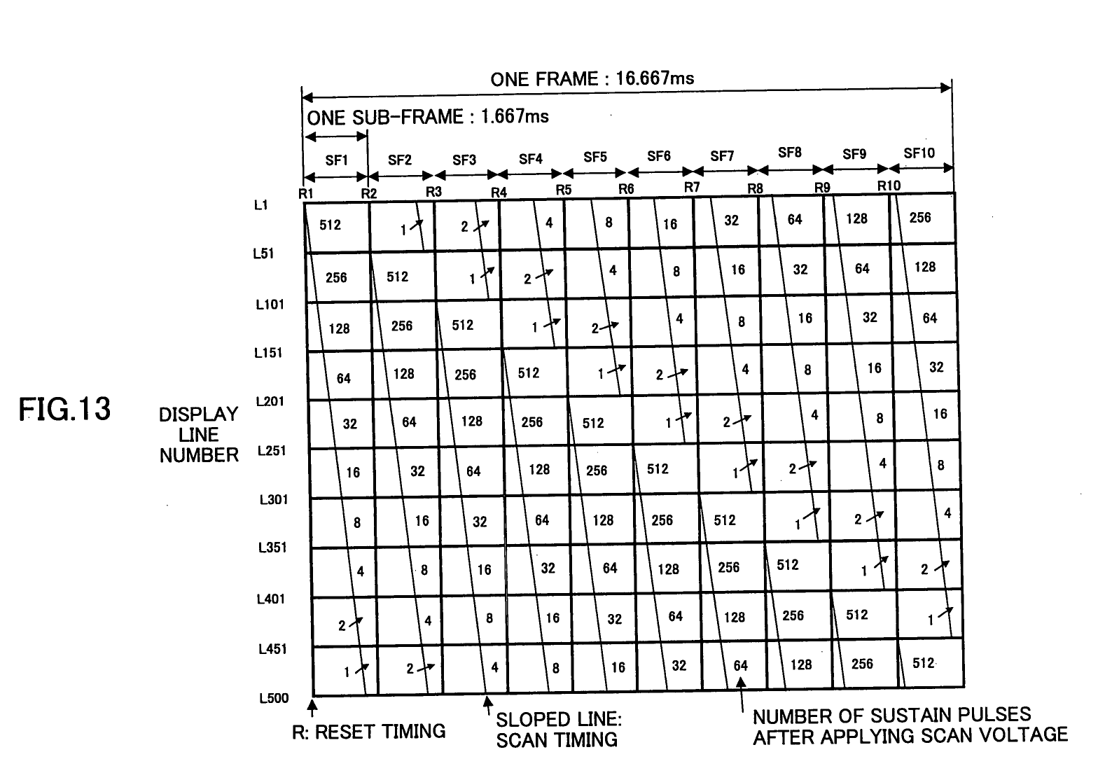

FIG. 13 is a drawing showing the configuration of an entire frame according to a second embodiment of a grayscale drive method of the present invention. In the second embodiment shown in FIG. 13, 10 sub-frames and 10-fold division are used for a panel having 500 display lines so as to provide 1024 gray scales.

When 10-fold division is made, every 50 lines of all the display lines are put together from the top to the bottom so as to generate 10 blocks in the same manner as in the first embodiment. Within each block, all the display lines are subjected to the sustain drive operation having the same duration and the same number of drive operations. In the second embodiment, the number of sustain drive operations is set to 512 for the display-line block that is subjected to the first address drive operation.

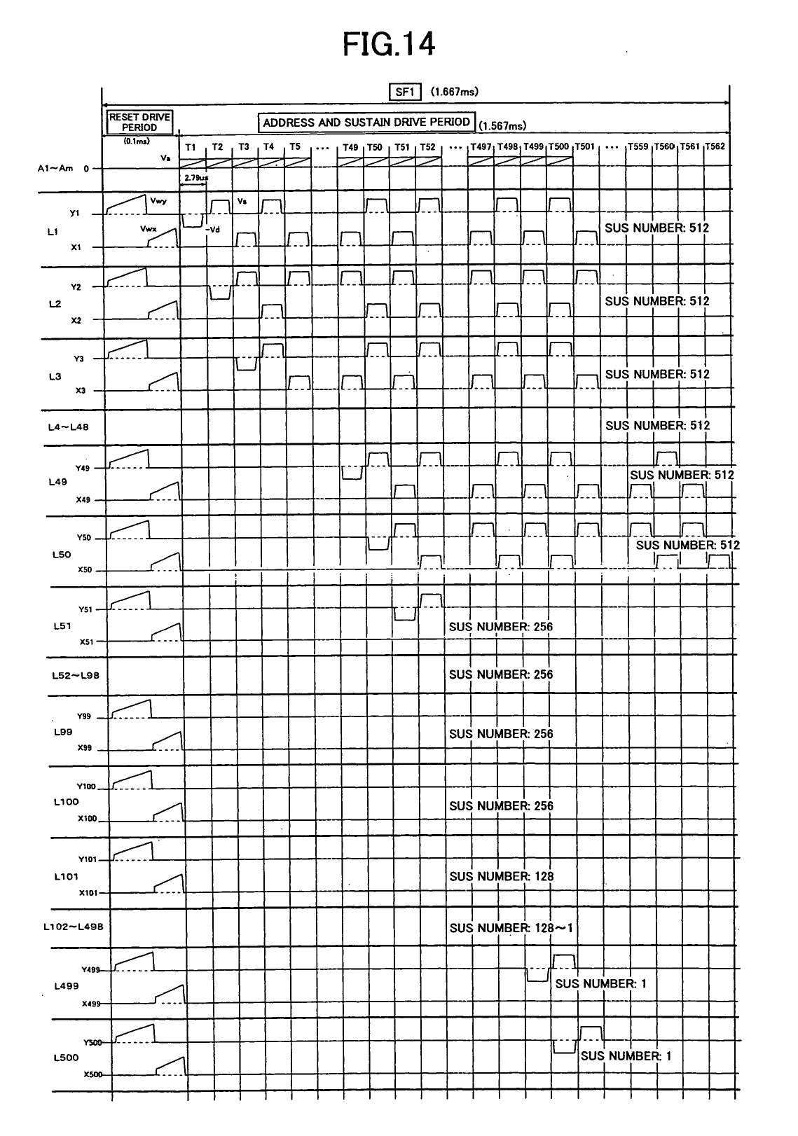

FIG. 14 is a drawing showing examples of drive waveforms for one of the sub-frames of the frame shown in FIG. 13, and illustrates the details for the sub-frame SF1 as a representative.

As shown in FIG. 14, the address and sustain drive period is divided into 562 timings T1 through T562. It is the block of the display lines L1 through L50 that is subjected to the first address drive operation in the first sub-frame SF1. The address drive operation starts from the display line L1, and is successively performed by moving to a next adjacent display line. After the address drive operation is completed with respect to the display line L50 at the timing T50, the sustain drive operation is performed with respect to the display line L50 from the timing T51. Since the last timing is T562, the maximum number of sustain drive operations is 512 (=562−50). Namely, with respect to each and every one of the display lines L1 through L50, the sustain drive operation is started at the timing immediately following the address drive operation, and is performed 512 times.

In this manner, when the 500-display-line panel is divided tenfold, and 10 sub-frames are used in the second embodiment, the address and sustain drive period is divided into the timings T1 through T562, which correspond to the number required to achieve the displaying of 1024 gray scales. A desired combination of sub-frames are then selected from these 10 sub-frames, thereby achieving the displaying of 1024 gray scales at the maximum (=512+256+128+64+32+16+8+4+2+1+1 [corresponding to the turned-off state]).

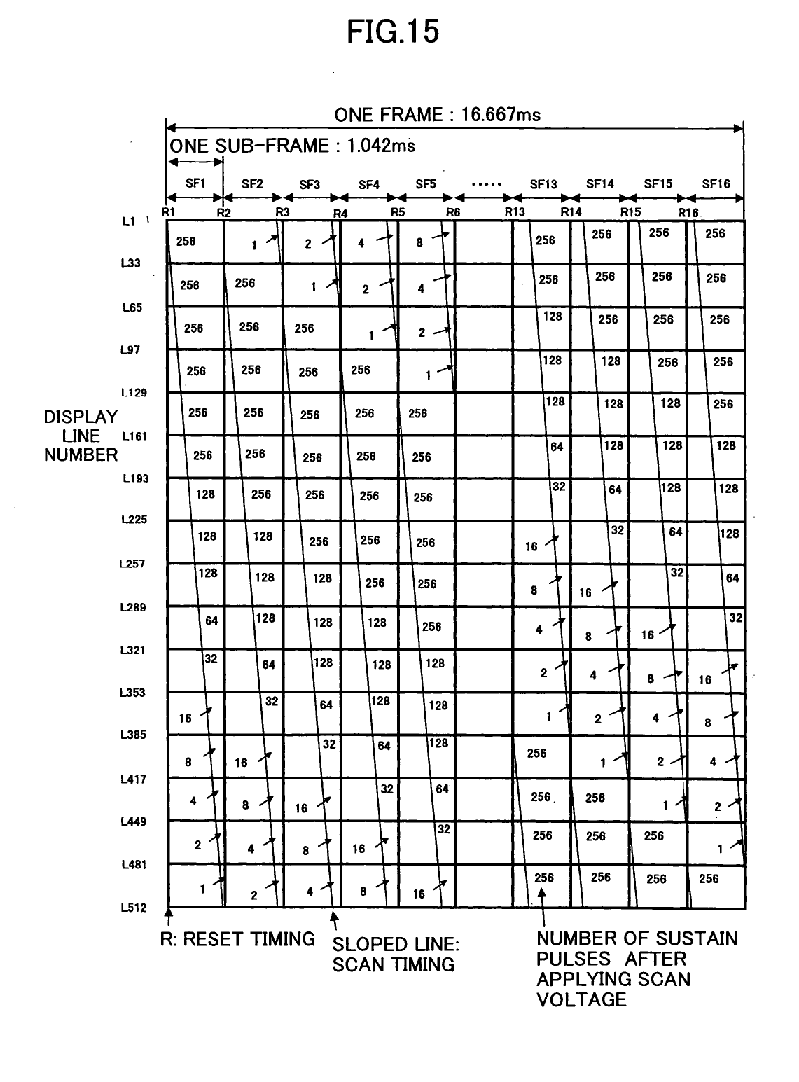

FIG. 15 is a drawing showing the configuration of an entire frame according to a third embodiment of a grayscale drive method of the present invention. In the third embodiment shown in FIG. 15, 16 sub-frames and 16-fold division are used for a panel having 512 display lines so as to provide 2048 gray scales.

When 16-fold division is made, every 32 lines of all the display lines are put together from the top to the bottom so as to generate 16 blocks. Within each block, all the display lines are subjected to the sustain drive operation having the same duration and the same number of drive operations. In the third embodiment, the number of sustain drive operations is set to 256 for the first display-line block through the sixth display-line block where the first display-line block is subjected to the first address drive operation. Further, the number of sustain drive operations is set to 128 for the seventh display-line block through the ninth display-line block. The numbers of sustain drive operations for tenth through sixteenth display-line blocks are set to 64, 32, 16, 8, 4, 2, and 1, respectively.

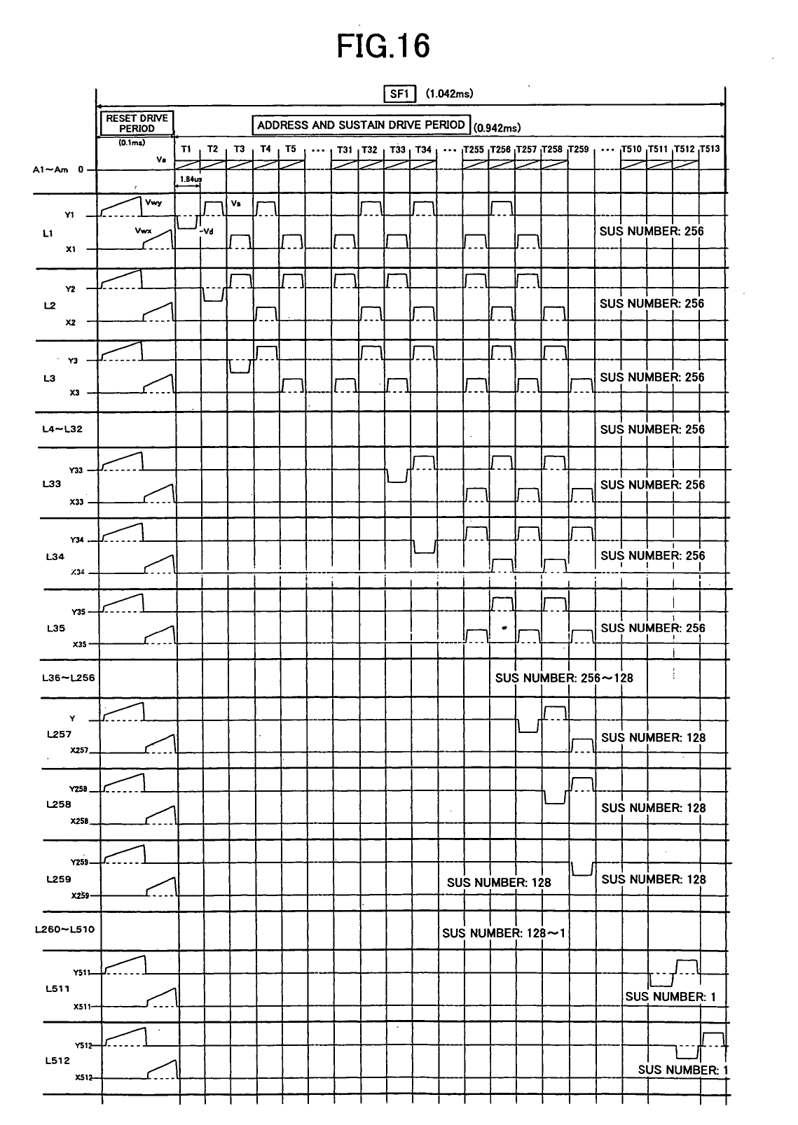

FIG. 16 is a drawing showing examples of drive waveforms for one of the sub-frames of the frame shown in FIG. 15, and illustrates the details for the sub-frame SF1 as a representative.

As shown in FIG. 16, the address and sustain drive period is divided into 513 timings T1 through T513. In the sub-frame SF1, the address drive operation starts from the display line L1, and is successively performed by moving to a next adjacent display line. After the address drive operation is performed with respect to the display line L512 at the timing T512, the sustain drive operation is performed with respect to the display line L512 at the timing T513.

In this manner, the 512-display-line panel is divided sixteen-fold, and 16 sub-frames are used in the third embodiment, with the address and sustain drive period being divided into the timings T1 through T512. A desired combination of sub-frames are then selected from these 16 sub-frames, thereby achieving the displaying of 2048 gray scales (=256×6+128×3+64+32+16+8+4+2+1+1 [corresponding to the turned-off state]).

The settings of the numbers of sustain drive operations for each sub-frame described above correspond to a case in which power-of-two values that are relatively easy to control are selected and combined to achieve the displaying of 2048 gray scales that is possible to provide the grayscale representation of the highest level for practical purposes. If the power-of-two values are not insisted upon, the number of sustain drive operations applicable to each display line block is 481 at the maximum (i.e., 513-32). The displaying of gray scales larger in number than 2048 gray scales is of course possible by using such number of sustain drive operations in combination and/or by setting the number of sustain drive operations to 256 for the seventh display-line block.

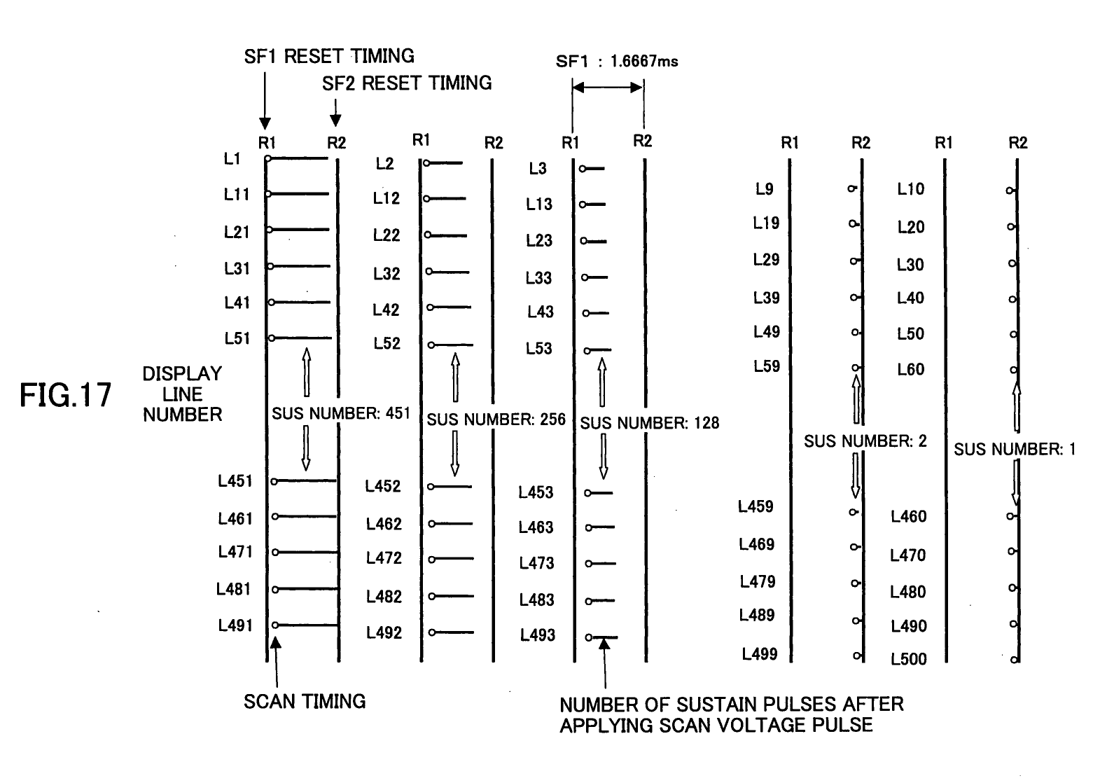

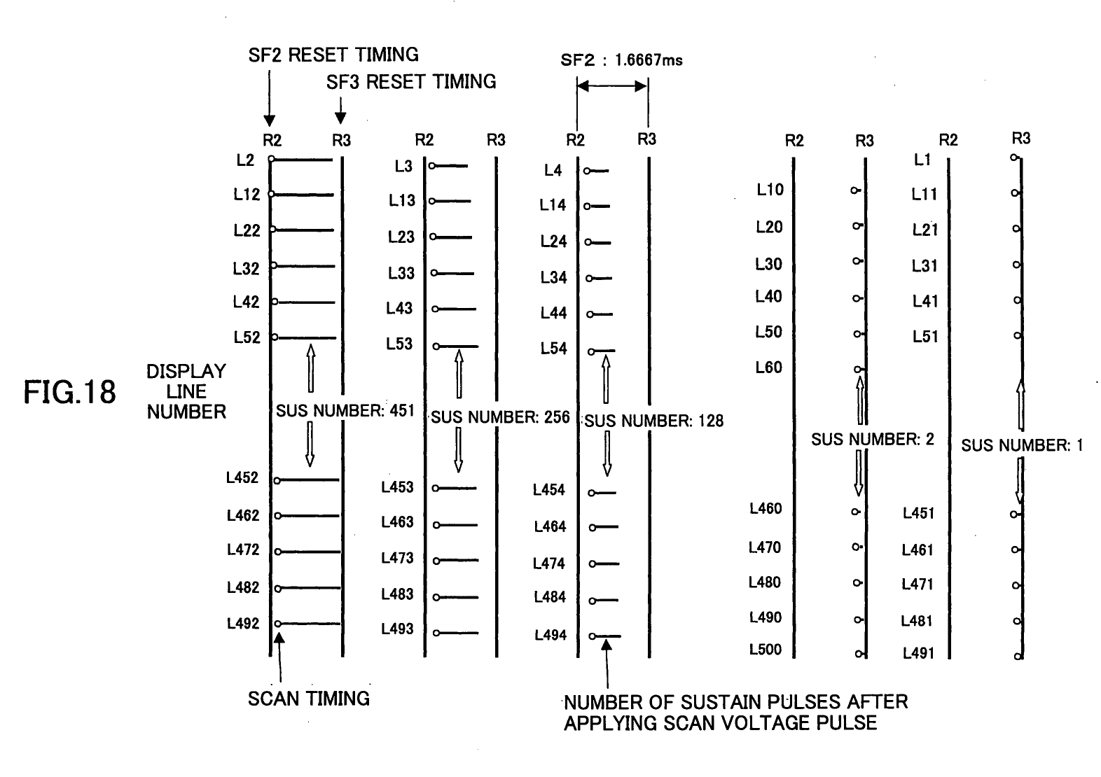

FIGS. 17 and 18 are drawings for explaining a fourth embodiment of a grayscale drive method of the present invention. In the fourth embodiment, a 10-sub-frame configuration is used for a 500-display-line panel to achieve the displaying of 963 gray scales in the same manner as in the first embodiment. Unlike the first embodiment, however, the display-line block that is subjected to the same number of sustain drive operations is not comprised of 50 consecutive display lines, but is comprised of 50 display lines obtained by selecting every tenth display line.

FIG. 17 is a drawing showing the configuration of the sub-frame SF1. As shown in FIG. 17, the display lines L1, L11, L21, . . . , L491 that are every tenth line constitute the first block, which is subjected to the first address drive operation in the sub-frame SF1. The number of sustain drive operations (SUS number) of the first block is 451. The second block is comprised of the display lines L2, L12, L22, . . . , L492, and is subjected to the address drive operation following the first block. The number of sustain drive operations (SUS number) of the second block is 256. The same applies to the remaining sub-blocks, so that the numbers of sustain drive operations for the first through tenth blocks in the sub-frame SF1 are set to 451, 256, 128, 64, 32, 16, 8, 4, 2, and 1.

FIG. 18 is a drawing showing the configuration of the sub-frame SF2. As shown in FIG. 18, the second block comprised of the display lines L2, L12, L22, . . . , L492 that are every tenth line is subjected to the first address drive operation in the sub-frame SF2. The number of sustain drive operations (SUS number) of the second block is 451. Thereafter, the third block comprised of the display lines L3, L13, L23, . . . , L493 is subjected to the address drive operation. The number of sustain drive operations (SUS number) of the third block is 256. The same applies to the remaining sub-blocks, so that the numbers of sustain drive operations for the second through tenth blocks and the first block in the sub-frame SF2 are set to 451, 256, 128, 64, 32, 16, 8, 4, 2, and 1.

In the fourth embodiment as described above, a display-line block is formed by selecting every tenth display line, and the address drive operation is successively performed in a predetermined block order, with the same number of sustain drive operations being used in the same block. In the present invention, when display lines are selected to constitute a display-line block, such selection is not limited to a specific method of selection. Display lines may be put together by use of any desired method to constitute a display-line block.

In the fourth embodiment described above, a display-line block does not form a single lump, but has the display lines thereof spaced apart in an evenly distributed manner, so that the numbers of sustain drive operations for adjacent display lines are different from each other, thereby achieving more smoother displaying of gray scales in the direction in which display lines are arranged side by side.

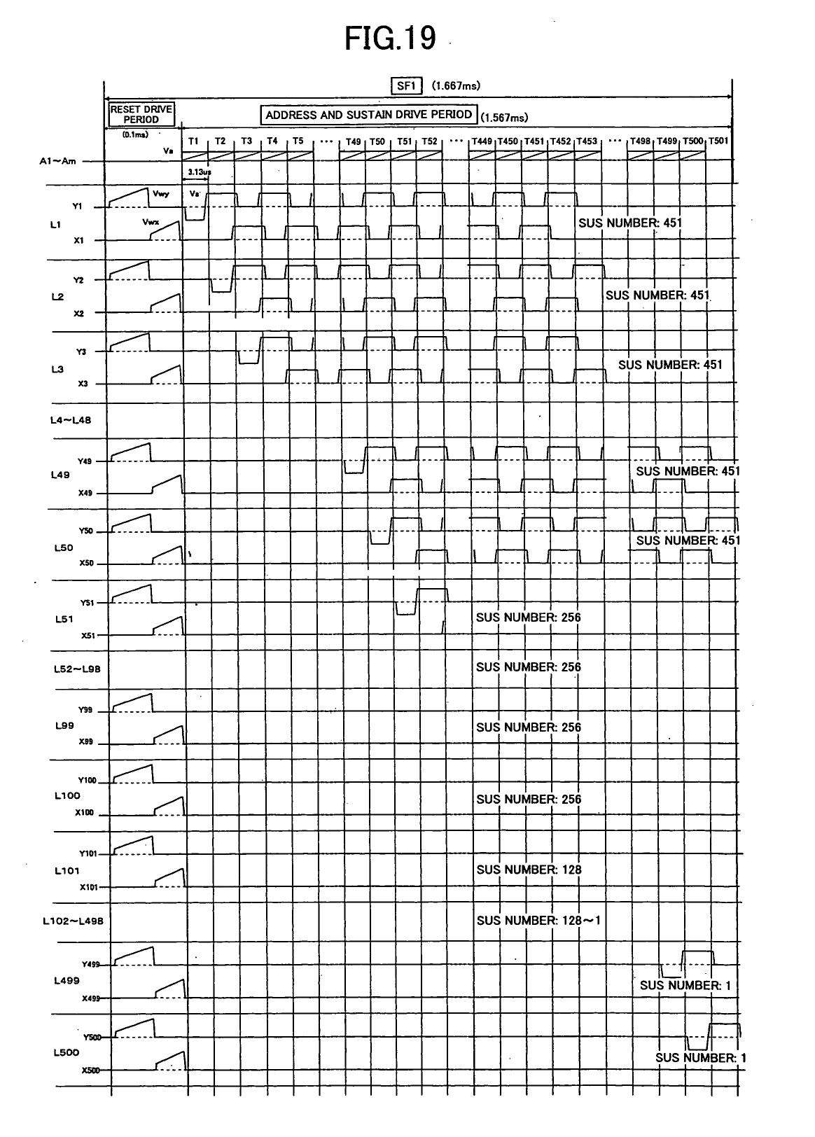

FIG. 19 is a drawing for explaining a fifth embodiment of a grayscale drive method of the present invention, and illustrates drive waveforms for the sub-frame SF1 as a representative. In the fifth embodiment, a 10-sub-frame configuration is used for a 500-display-line panel to achieve the displaying of 963 gray scales in the same manner as in the first embodiment.

The fifth embodiment differs from the first embodiment in that the sustain drive waveforms as shown in FIG. 10 are used. Namely, the sustain voltage pulses for the Y electrodes and the sustain voltage pulses for the X electrodes are configured to overlap each other. This ensures that the sustain voltage is always present between the Y electrodes and the X electrodes during the sustain drive period, so that the created wall charge is stuck to the Y electrodes or X electrodes at all times. With this provision, the effect of application of voltages to the address electrodes on the sustain drive operation can almost be ignored. The frame configuration and sub-frame configuration other than what is described above are the same as in the first embodiment, and a description thereof will be omitted.

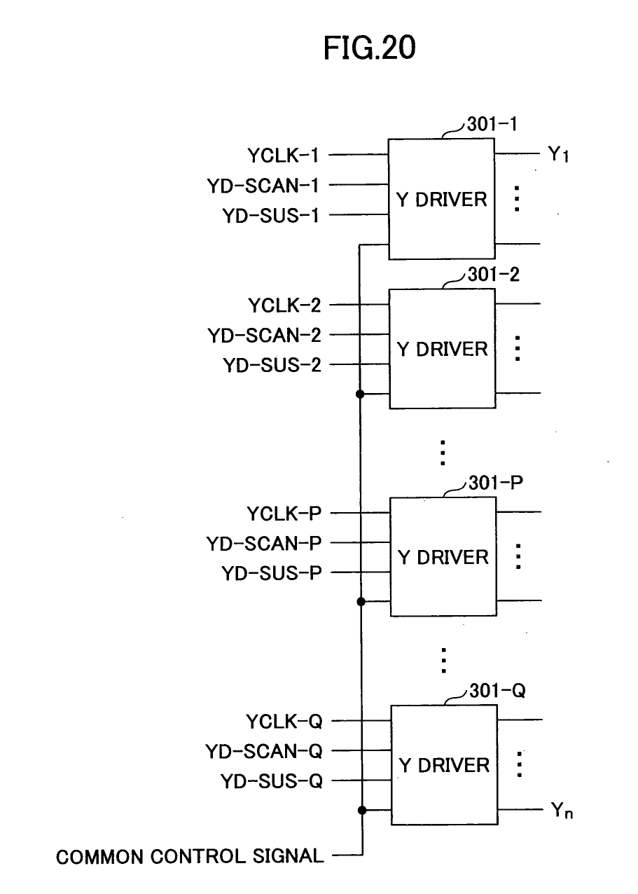

FIG. 20 is a drawing showing an example of the configuration of the Y-electrode scan driver circuit 202 that achieves the embodiments described above. The Y-electrode scan driver circuit 202 of FIG. 20 includes Y drivers 301-1 through 301-Q. This is an example in which the display lines are divided into Q blocks.

The P-th Y driver 301-P receives a clock signal YCLK-P, a scan timing signal YD-SCAN-P, and a Y-electrode sustain-drive-timing signal YD-SUS-P from the Y-electrode control unit 213. The Y-electrode control unit 213 supplies the scan timing signal YD-SCAN-P together with the clock signal YCLK-P to the Y driver 301-P at the time of address drive operation with respect to the P-th block. The Y-electrode control unit 213 further supplies the Y-electrode sustain-drive-timing signal YD-SUS-P together with the clock signal YCLK-P to the Y driver 301-P at the time of a sustain drive operation with respect to the P-th block. Further, a common control signal is supplied in common to the Y drivers 301-1 through 301-Q.

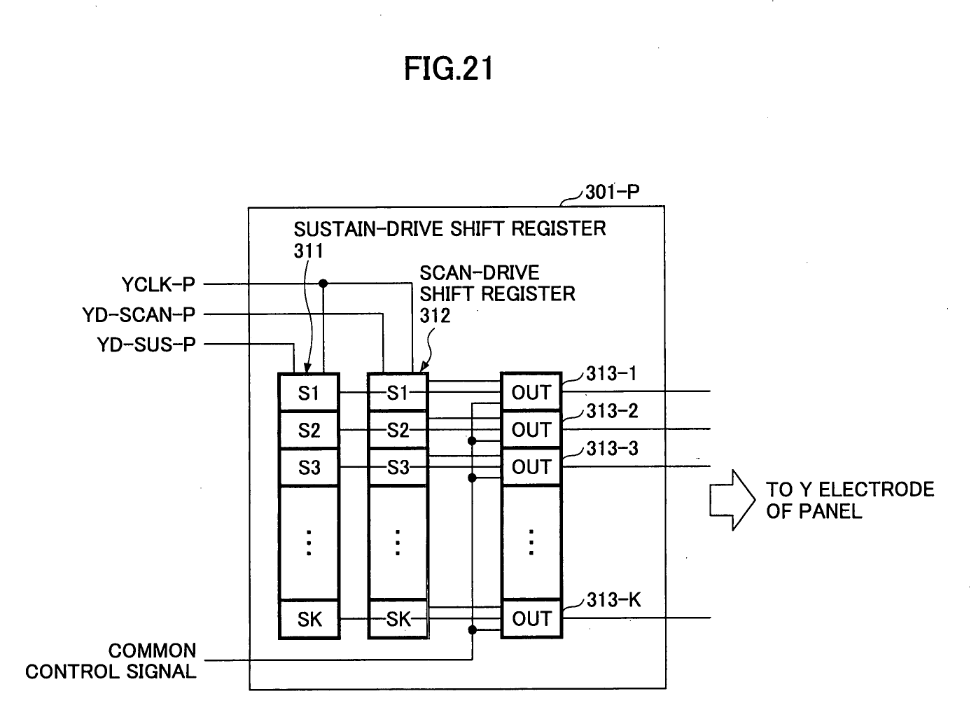

FIG. 21 is a drawing showing an example of the configuration of the Y driver 301-P. The Y driver 301-P includes a sustain-drive shift register 311, a scan-drive shift register 312, and high-voltage output circuits (OUT) 313-1 through 313-k. This is an example in which one display-line block corresponds to k display lines. The high-voltage output circuits 313-1 through 313-k are coupled in one-to-one correspondence to k Y-electrodes. The basic circuit configuration of the last stage of the output of the high-voltage output circuits is shown in FIG. 8 as an example, and a description thereof will be omitted.

The sustain-drive shift register 311 includes k flip-flops S1 through Sk. The sustain-drive shift register 311 receives the Y-electrode sustain-drive-timing signal YD-SUS-P from the Y-electrode control unit 213, and makes the Y-electrode sustain-drive-timing signal YD-SUS-P propagate through the flip-flops S1 through Sk by storing the signal in the flip-flops successively. This successive storing and propagation are performed in synchronization with the clock signal YCLK-P.

The scan-drive shift register 312 includes k flip-flops S1 through Sk. The scan-drive shift register 312 receives the scan timing signal YD-SCAN-P from the Y-electrode control unit 213, and allows the scan timing signal YD-SCAN-P to propagate through the flip-flops S1 through Sk by storing the signal in the flip-flops successively. This successive storing and propagation are performed in synchronization with the clock signal YCLK-P.

The high-voltage output circuits 313-1 through 313-k receive the respective outputs of the flip-flops S1 through Sk of the sustain-drive shift register 311, and also receive the respective outputs of the flip-flops S1 through Sk of the scan-drive shift register 312. Further, the common control signal is supplied in common to the high-voltage output circuits 313-1 through 313-k.

Each of the high-voltage output circuits 313-1 through 313-k drives a Y electrode by the address drive voltage when the signal received from the corresponding flip-flop of the scan-drive shift register 312 is in the asserted state. This achieves the address drive (scan drive) operation. Further, each of the high-voltage output circuits 313-1 through 313-k drives a Y electrode by the sustain drive voltage in response to the common control signal when the signal received from the corresponding flip-flop of the sustain-drive shift register 311 is in the asserted state. With this arrangement, the sustain drive operation is achieved. In this manner, the sustain drive timings of the high-voltage output circuits 313-1 through 313-k are controlled in response to respective timing control signals (i.e., the Y-electrode sustain-drive-timing signal YD-SUS-P propagating through the sustain-drive shift register 311) that indicate different timings.

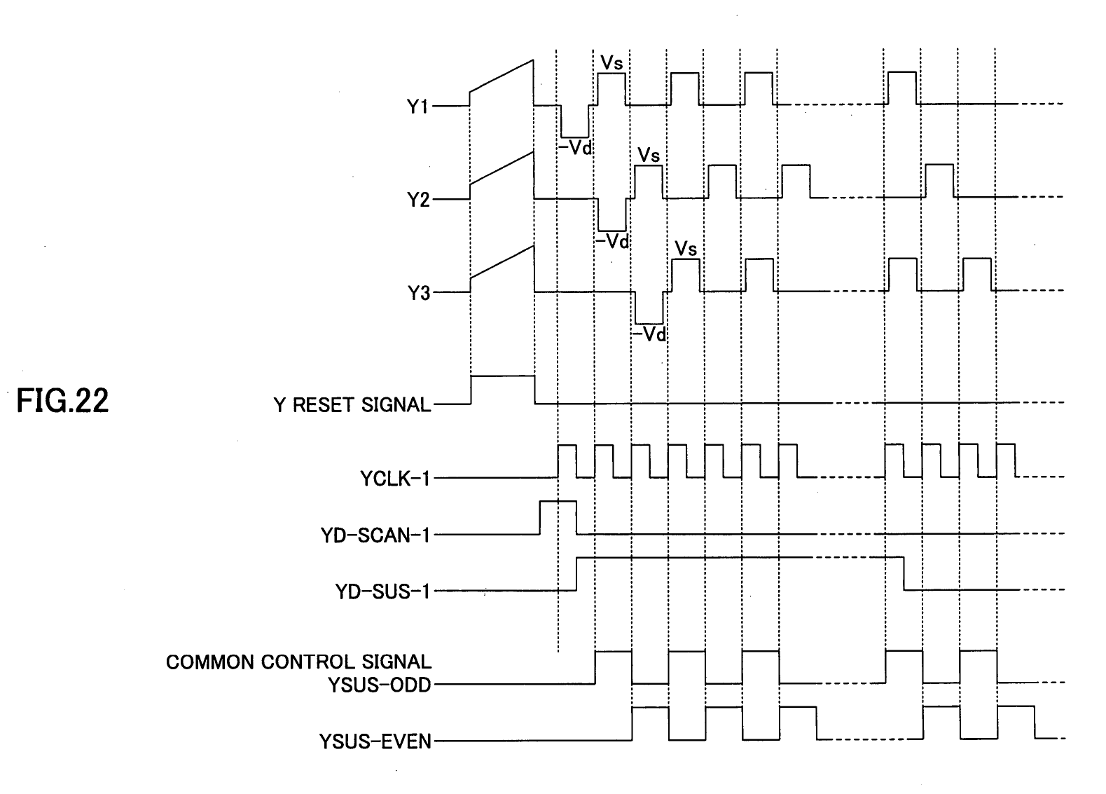

FIG. 22 is a drawing showing signal waveforms generated by the Y-electrode scan driver circuit shown in FIG. 20 and FIG. 21. As shown in FIG. 22, a reset voltage waveform is applied to the Y electrodes Y1 through Y3 in response to a reset signal (which is a signal generated by the Y-electrode common-reset-voltage-waveform generating circuit 203). After this, a clock signal YCLK-1, a scan timing signal YD-SCAN-1, and a Y-electrode sustain-drive-timing signal YD-SUS-1 are received from the Y-electrode control unit 213. Upon the receipt, the Y electrode Y1 is subjected to the address drive operation (voltage: −Vd) at the timing responsive to the scan timing signal YD-SCAN-1. Thereafter, as the scan timing signal YD-SCAN-1 propagates through the scan-drive shift register 312, the address drive operation (voltage: −Vd) is successively performed with respect to the Y electrodes Y2, Y3, . . . , and so on.

Further, the Y electrode Y1 is subjected to the sustain drive operations (voltage: Vs) at the timing responsive to the Y-electrode sustain-drive-timing signal YD-SUS-1 (i.e., at the timing corresponding to the HIGH period of the Y-electrode sustain-drive-timing signal YD-SUS-1). Thereafter, as the Y-electrode sustain-drive-timing signal YD-SUS-1 propagates through the sustain-drive shift register 311, the sustain drive operations (voltage: Vs) are successively performed with respect to the Y electrodes Y2, Y3, . . . , and so on. The sustain drive pulses for the even-number Y electrodes are generated in response to the pulses of a common control signal YSUS-EVEN, and the sustain drive pulses for the odd-number Y electrodes are generated in response to the pulses of a common control signal YSUS-ODD.

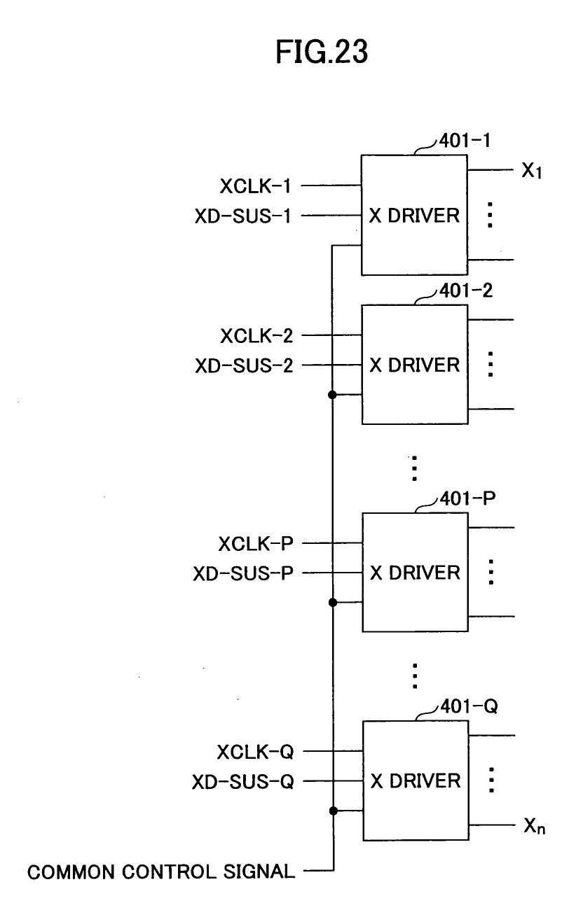

FIG. 23 is a drawing showing an example of the configuration of the X-electrode driver circuit 204 that achieves the embodiments described above. The X-electrode driver circuit 204 of FIG. 23 includes X drivers 401-1 through 401-Q. This is an example in which the display lines are divided into Q blocks.

The P-th X driver 401-P receives a clock signal XCLK-P and an X-electrode sustain-drive-timing signal XD-SUS-P from the X-electrode control unit 214. The X-electrode control unit 214 supplies the X-electrode sustain-drive-timing signal XD-SUS-P together with the clock signal XCLK-P to the X driver 401-P at the time of sustain drive operation with respect to the P-th block. Further, a common control signal is supplied in common to the X drivers 401-1 through 401-Q.

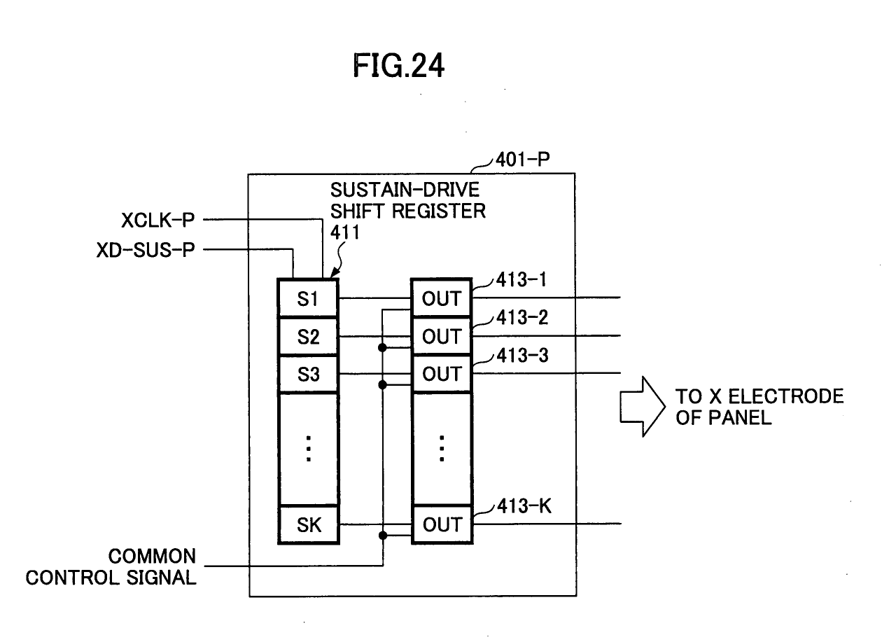

FIG. 24 is a drawing showing an example of the configuration of the X driver 401-P. The X driver 401-P includes a sustain-drive shift register 411 and high-voltage output circuits (OUT) 413-1 through 413-k. This is an example in which one display-line block corresponds to k display lines. The high-voltage output circuits 413-1 through 413-k are coupled in one-to-one correspondence to k X-electrodes. The basic circuit configuration of the last stage of the output of the high-voltage output circuits is shown in FIG. 8 as an example, and a description thereof will be omitted.

The sustain-drive shift register 411 includes k flip-flops S1 through Sk. The sustain-drive shift register 411 receives the X-electrode sustain-drive-timing signal XD-SUS-P from the X-electrode control unit 214, and makes the X-electrode sustain-drive-timing signal XD-SUS-P propagate through the flip-flops S1 through Sk by successively storing the signal in the flip-flops starting with the flip-flop S1. This successive storing and propagation are performed in synchronization with the clock signal XCLK-P.

The high-voltage output circuits 413-1 through 413-k receive the outputs of the respective flip-flops S1 through Sk of the sustain-drive shift register 411. Further, the common control signal is supplied in common to the high-voltage output circuits 413-1 through 413-k.

Further, each of the high-voltage output circuits 413-1 through 413-k drives an X electrode by the sustain drive voltage in response to the common control signal when the signal received from the corresponding flip-flop of the sustain-drive shift register 411 is in the asserted state. With this arrangement, the sustain drive operation is achieved. In this manner, the sustain drive timings of the high-voltage output circuits 413-1 through 413-k are controlled in response to respective timing control signals (i.e., the X-electrode sustain-drive-timing signal XD-SUS-P propagating through the sustain-drive shift register 411) that indicate different timings.

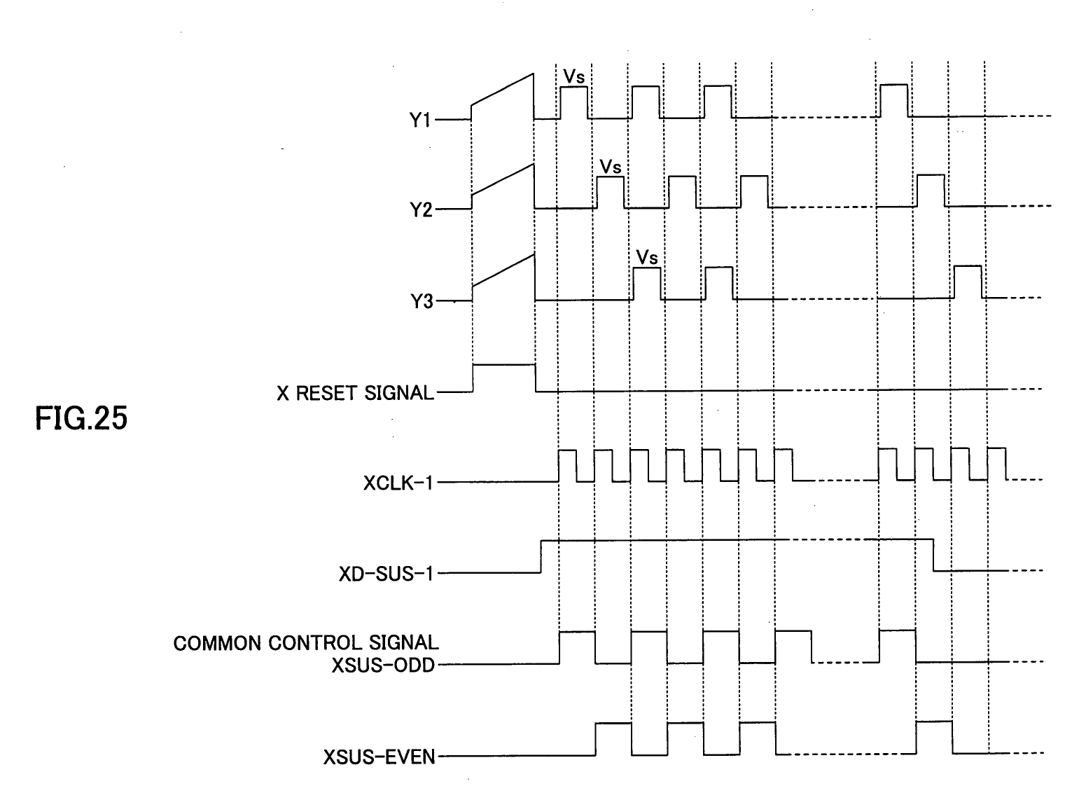

FIG. 25 is a drawing showing signal waveforms generated by the X-electrode driver circuit shown in FIG. 23 and FIG. 24. As shown in FIG. 25, a reset voltage waveform is applied to the X electrodes X1 through X3 in response to a reset signal (which is a signal generated by the X-electrode common-reset-voltage-waveform generating circuit 205). Thereafter, upon the receipt of the clock signal XCLK-1 and the X-electrode sustain-drive-timing signal XD-SUS-1 from the X-electrode control unit 214, the X electrode X1 is subjected to the sustain drive operations (voltage: Vs) at the timing responsive to the X-electrode sustain-drive-timing signal XD-SUS-1 (i.e., at the timing corresponding to the HIGH period of the X-electrode sustain-drive-timing signal XD-SUS-1). Thereafter, as the X-electrode sustain-drive-timing signal XD-SUS-1 propagates through the sustain-drive shift register 411, the sustain drive operations (voltage: Vs) are successively performed with respect to the X electrodes X2, X3, . . . , and so on. The sustain drive pulses for the even-number X electrodes are generated in response to the pulses of a common control signal XSUS-EVEN, and the sustain drive pulses for the odd-number X electrodes are generated in response to the pulses of a common control signal XSUS-ODD.

Further, the present invention is not limited to these embodiments, but various variations and modifications may be made without departing from the scope of the present invention.

In the above disclosure, the embodiments of the present invention have been described with reference to a three-electrode-type flat-plane-discharge AC-PDP panel as an example. The present invention is not limited to this configuration, and is equally applicable to two-electrode-type AC-PDP that utilizes gas discharge.

The present application is based on Japanese priority application No. 2005-365098 filed on Dec. 19, 2005, with the Japanese Patent Office, the entire contents of which are hereby incorporated by reference.

What is claimed is:

1. A circuit for driving a plasma display panel in which display cells are constituted at least by a set of electrodes including first electrodes extending in a first direction, second electrodes extending in the first direction, and third electrodes extending in a second direction substantially perpendicular to the first direction, comprising:
a first driver circuit configured to drive the first electrodes;
a second driver circuit configured to drive the second electrodes;
a third driver circuit configured to drive the third electrodes; and
a control circuit configured to control the first through third driver circuits such as to perform an address drive operation and a sustain drive operation simultaneously in parallel by performing the sustain drive operation to apply a sustain voltage between a first electrode and a second electrode adjacent to each other so as to sustain electric discharge at the display cells while performing the address drive operation to successively apply a scan voltage to the first electrodes and apply an address voltage to the third electrodes so as to select the display cells.

2. The circuit as claimed in claim 1, wherein the first driver circuit is configured to apply a negative polarity voltage as the scan voltage to the first electrodes, and the third driver circuit is configured to apply a positive polarity voltage as the address voltage to the third electrodes, and wherein the first driver circuit and the second driver circuit are configured to apply a positive polarity voltage as the sustain voltage to the first electrodes and the second electrodes, respectively.

3. The circuit as claimed in claim 1, wherein during the sustain drive operation, the applying of the sustain voltage to the first electrode by the first driver circuit and the applying of the sustain voltage to the second electrode by the second driver circuit are performed alternately, and have overlapping time periods during which the application of the sustain voltage to the first electrode and the application of the sustain voltage to the second electrode overlap each other.

4. The circuit as claimed in claim 1, wherein a number of times the sustain voltage is applied to the first electrode and the second electrode adjacent to each other is a first number with respect to a first electrode for which the applying of the scan voltage is completed at first timing, and is a second number with respect to a first electrode for which the applying of the scan voltage is completed at second timing later than the first timing, the second number being smaller than the first number.

5. The circuit as claimed in claim 1, wherein the control circuit is configured to change an order in which the scan voltage is successively applied to the first electrodes, so that the order changes with time.

6. The circuit as claimed in claim 1, wherein the control circuit is configured to perform the sustain drive operation for a predetermined period following a completion of the address drive operation.

7. The circuit as claimed in claim 1, wherein the first driver circuit includes:
first output circuits coupled in one-to-one correspondence to the first electrodes and configured to output the sustain voltage; and
circuits coupled to the first output circuits, respectively, and configured to supply signals separately for each of the first output circuits, the signals controlling timing at which the first output circuits output the sustain voltage,
and wherein the second driver circuit includes:
second output circuits coupled in one-to-one correspondence to the second electrodes and configured to output the sustain voltage; and
circuits coupled to the second output circuits, respectively, and configured to supply signals separately for each of the second output circuits, the signals controlling timing at which the second output circuits output the sustain voltage.

8. A method of driving a plasma display panel in which display cells are constituted at least by a set of electrodes including first electrodes extending in a first direction, second electrodes extending in the first direction, and third electrodes extending in a second direction substantially perpendicular to the first direction, comprising:
a reset drive step of applying a reset voltage to the first electrodes and the second electrodes;
an address drive step of successively applying a scan voltage to the first electrodes and applying an address voltage to the third electrodes so as to select the display cells; and
a sustain drive step of applying a sustain voltage between a first electrode and a second electrode adjacent to each other so as to sustain electric discharge at the display cells,
wherein the address drive step and the sustain drive step are performed at least partially simultaneously in parallel.

9. The method as claimed in claim 8, wherein during the address drive step, a negative polarity voltage is applied as the scan voltage to the first electrodes, and a positive polarity voltage is applied as the address voltage to the third electrodes, and wherein during the sustain drive step, a positive polarity voltage is applied as the sustain voltage to the first electrodes and the second electrodes.

10. The method as claimed in claim 8, wherein during the sustain drive operation, the applying of the sustain voltage to the first electrode and the applying of the sustain voltage to the second electrode are performed alternately, and have overlapping time periods during which the application of the sustain voltage to the first electrode and the application of the sustain voltage to the second electrode overlap each other.

11. The method as claimed in claim 8, wherein during the sustain drive period, a number of times the sustain voltage is applied to the first electrode and the second electrode adjacent to each other is a first number with respect to a first electrode for which the applying of the scan voltage is completed at first timing, and is a second number with respect to a first electrode for which the applying of the scan voltage is completed at second timing later than the first timing, the second number being smaller than the first number.

12. The method as claimed in claim 8, wherein the sustain drive step is performed for a predetermined period following a completion of the address drive step.

13. The method as claimed in claim 8, wherein the reset drive step, the address drive step, and the sustain drive step are combined as one set to form a sub-frame, the method further comprising a step of repeating the sub-frame a predetermined number of times.

14. The method as claimed in claim 13, further comprising a step of changing, on a sub-frame-by-sub-frame basis, an order in which the scan voltage is successively applied to the first electrodes during the address drive step.

15. The method as claimed in claim 13, wherein the sub-frame is repeated N times (N: an integer equal to or more than 2) to constitute one field comprised of N sub-frames, and the sustain voltage is applied to the first electrode and the second electrode adjacent to each other 2⁰ times through 2^{N} times in the N sub-frames, respectively.

16. A plasma display apparatus, comprising:
a plasma display panel in which display cells are constituted at least by a set of electrodes including first electrodes extending in a first direction, second electrodes extending in the first direction, and third electrodes extending in a second direction substantially perpendicular to the first direction;
a first driver circuit configured to drive the first electrodes;
a second driver circuit configured to drive the second electrodes;
a third driver circuit configured to drive the third electrodes; and
a control circuit configured to control the first through third driver circuits such as to perform an address drive operation and a sustain drive operation simultaneously in parallel by performing the sustain drive operation to apply a sustain voltage between a first electrode and a second electrode adjacent to each other so as to sustain electric discharge at the display cells while performing the address drive operation to successively apply a scan voltage to the first electrodes and apply an address voltage to the third electrodes so as to select the display cells.
